(19) United States
(12) Patent Application Publication
(10) Pub. No.: US 2026/0185656 A1
(43) Pub. Date: Jul. 2, 2026

(54) ELECTRIC-POWERED LUBRICATOR

(71) Applicant: MAKITA CORPORATION, Anjo-shi (JP)

(72) Inventors: Yuki HAYASHI, Anjo-shi (JP); Hidefumi HAGIWARA, Anjo-shi (JP)

(73) Assignee: MAKITA CORPORATION, Anjo-shi (JP)

(21) Appl. No.: 19/428,913

(22) Filed: Dec. 22, 2025

(30) Foreign Application Priority Data
Dec. 27, 2024 (JP) 2024-232525

(51) Int. Cl. F16N 5/00; F16N 7/38; F16N 13/06; F16N 27/00

(52) U.S. Cl. CPC F16N 5/00; F16N 7/38; F16N 13/06; F16N 27/00; F16N 2013/063

(57) ABSTRACT

An electric-powered lubricator according to one aspect of the present disclosure includes a motor, a drive circuit, a pump, a drive switch, a selection switch, and a control circuit. The selection switch is manually operated by a user to select a first mode or a second mode. The first mode and the second mode are operation modes of the electric-powered lubricator, the first mode associates an operation amount of the drive switch with a rotational speed in a first relationship, and the second mode associates the operation amount of the drive switch with the rotational speed in a second relationship different from the first relationship.

### CROSS-REFERENCE TO RELATED APPLICATIONS

The present application claims priority based on Japanese Patent Application No. 2024-232525 filed in the Japan Patent Office on Dec. 27, 2024, the content of which is incorporated herein by reference in its entirety.

### BACKGROUND

The present disclosure relates to an electric-powered lubricator.

A grease dispensing device disclosed in Japanese Unexamined Patent Application No. 2024-134818 includes a trigger, a pump that dispenses grease, a motor that operates the pump, an inverter that drives the motor, and a control circuit. The control circuit controls the inverter to rotate the motor at a rotational speed corresponding to a pulling amount of the trigger. As a result, the pump dispenses grease at a speed corresponding to the rotational speed of the motor.

### SUMMARY

In a case where a user uses the aforementioned grease dispensing device, the user can adjust the rotational speed of the motor, but cannot adjust operations of the grease dispensing device other than the rotational speed. Therefore, the grease dispensing device has room for improvement in convenience.

One aspect of the present disclosure, it is desirable to provide an electric-powered lubricator having excellent convenience.

The electric-powered lubricator according to one aspect of the present disclosure includes a motor, a drive circuit, a pump, a drive switch, a selection switch, and a control circuit. The motor generates a driving force. The drive circuit drives the motor. The pump includes a dispensing port for dispensing a lubricant. The pump dispenses the lubricant from the dispensing port at a speed corresponding to a rotational speed of the motor by the driving force generated by the motor. The drive switch is manually operated by a user to drive the motor. The selection switch is manually operated by the user to select a first mode or a second mode. The first mode and the second mode each is an operation mode of the electric-powered lubricator. The first mode associates an operation amount of the drive switch with the rotational speed in a first relationship. The second mode associates the operation amount of the drive switch with the rotational speed in a second relationship different from the first relationship. A variable speed range in the first relationship is wider than a variable speed range in the second relationship. The variable speed range is defined as a range where the rotational speed changes according to the operation amount. The control circuit controls the motor through the drive circuit based on (i) an actual operation amount of the drive switch manually operated and (ii) the first mode or the second mode selected through the selection switch.

The above electric-powered lubricator has the two operation modes having different correspondence relationships between the operation amount of the drive switch and the rotational speed of the motor. According to the above electric-powered lubricator, the user can select one of the two operation modes, so that the degree of freedom in adjusting the operations of the electric-powered lubricator is increased. In the first mode, the user can finely adjust the rotational speed of the motor according to the operation amount of the drive switch. Therefore, the convenience of the electric-powered lubricator is improved.

A method of controlling dispensing of a lubricant from an electric-powered lubricator according to another aspect of the present disclosure includes:
setting a first mode or a second mode as an operation mode of the electric-powered lubricator based on manual operation of a selection switch of the electric-powered lubricator by a user, the first mode associating an operation amount of a drive switch of the electric-powered lubricator with a rotational speed of a motor in a first relationship, the motor being configured to drive a pump of the electric-powered lubricator, the second mode associating the operation amount with the rotational speed in a second relationship different from the first relationship, a variable speed range in the first relationship being wider than a variable speed range in the second relationship, and the variable speed range being defined as a range where the rotational speed changes according to the operation amount; and
controlling the motor based on (i) an actual operation amount of the drive switch and (ii) the operation mode set through the selection switch on the basis of manual operation of the drive switch by the user.

According to the above method, the same effects as those of the above electric-powered lubricator are obtained.

### BRIEF DESCRIPTION OF THE DRAWINGS

An example embodiment of the present disclosure will be described hereinafter with reference to the accompanying drawings, in which:

FIG. 1 is a perspective view of an electric-powered lubricator according to a first embodiment.

FIG. 2 is a central longitudinal sectional view of the electric-powered lubricator according to the first embodiment.

FIG. 3 is a plan view of an operation panel of the electric-powered lubricator according to the first embodiment.

FIG. 4 is a diagram illustrating an electrical configuration of the electric-powered lubricator according to the first embodiment.

FIG. 5 is a diagram illustrating a functional configuration of a control circuit according to the first embodiment.

FIG. 6 is a diagram illustrating a desired rotational speed, an actual rotational speed, a motor current, and a stroke of a plunger during acceleration of a motor of the electric-powered lubricator according to the first embodiment.

FIG. 7 is a diagram illustrating a desired rotational speed, an actual rotational speed, a motor current, and a stroke of the plunger during deceleration of the motor of the electric-powered lubricator according to the first embodiment.

FIG. 8 is a diagram illustrating a dispensing speed (a rotational speed of the motor) with respect to a pulling amount of a trigger in a first mode of the electric-powered lubricator according to the first embodiment.

FIG. 9 is a diagram illustrating a dispensing speed (a rotational speed of the motor) with respect to a pulling amount of the trigger in a second mode of the electric-powered lubricator according to the first embodiment.

FIG. 10 is a flowchart illustrating main process executed by the control circuit according to the first embodiment.

FIG. 11 is a flowchart illustrating desired rotational speed setting process executed by the control circuit according to the first embodiment.

FIG. 12 is a flowchart illustrating stop state process in the first mode executed by the control circuit according to the first embodiment.

FIG. 13 is a flowchart illustrating stop state process in the second mode executed by the control circuit according to the first embodiment.

FIG. 14 is a flowchart illustrating operation state process in the first mode executed by the control circuit according to the first embodiment.

FIG. 15 is a flowchart illustrating operation state process in the second mode executed by the control circuit according to the first embodiment.

FIG. 16 is a diagram illustrating a dispensing speed (a rotational speed of a motor) with respect to a pulling amount of a trigger in a second mode according to a second embodiment.

FIG. 17 is a flowchart illustrating desired rotational speed setting process executed by a control circuit according to the second embodiment.

FIG. 18 is a diagram illustrating a dispensing speed (a rotational speed of a motor) with respect to a pulling amount of a trigger in a second mode according to a third embodiment.

FIG. 19 is a flowchart illustrating desired rotational speed setting process executed by a control circuit according to the third embodiment.

FIG. 20 is a flowchart illustrating main process executed by a control circuit according to a fourth embodiment.

FIG. 21 is a flowchart illustrating continuation determination process executed by the control circuit according to the fourth embodiment.

### DETAILED DESCRIPTION OF EXEMPLARY EMBODIMENTS

### Summary of Embodiments

One embodiment may provide an electric-powered lubricator (or an electric oil syringe or an electric grease gun) including at least any one of:
Feature 1: a motor configured to generate a driving force;
Feature 2: a drive circuit configured to drive the motor;
Feature 3: a pump including a dispensing port configured to dispense a lubricant, and configured to dispense the lubricant from the dispensing port at a speed corresponding to a rotational speed of the motor by the driving force generated by the motor;
Feature 4: a drive switch configured to be manually operated by a user to drive the motor;
Feature 5: a selection switch configured to be manually operated by the user to select a first mode or a second mode;
Feature 6: the first mode and the second mode each is an operation mode of the electric-powered lubricator;
Feature 7: the first mode associates an operation amount of the drive switch with the rotational speed in a first relationship;
Feature 8: the second mode associates the operation amount of the drive switch with the rotational speed in a second relationship different from the first relationship;
Feature 9: a variable speed range in the first relationship is wider than a variable speed range in the second relationship;
Feature 10: the variable speed range is defined as a range where the rotational speed changes according to the operation amount; and
Feature 11: a control circuit configured to control the motor through the drive circuit based on (i) an actual operation amount of the drive switch manually operated and (ii) the first mode or the second mode selected through the selection switch.

The electric-powered lubricator including at least the features 1 to 11 has the two operation modes having different correspondence relationships between the operation amount of the drive switch and the rotational speed of the motor. Since the user can select one of the two operation modes, the degree of freedom in adjusting operations of the electric-powered lubricator is increased. In the first mode, the user can finely adjust the rotational speed of the motor according to the operation amount of the drive switch. Therefore, the convenience of the electric-powered lubricator is improved.

In one embodiment, in addition to or in place of at least any one of the features 1 to 11, the following feature may be included:
Feature 12: the control circuit continuously drives the motor through the drive circuit while the drive switch is being operated based on the first mode being selected through the selection switch.

In the electric-powered lubricator including at least the features 1 to 12, in the case of selecting the first mode, the user can adjust a dispensed amount of lubricant while operating the drive switch.

In one embodiment, in addition to or in place of at least any one of the features 1 to 12, the following feature may be included:
Feature 13: the control circuit stops the motor through the drive circuit based on (i) the second mode being selected through the selection switch and (ii) a set amount of the lubricant having been dispensed from the dispensing port.

In the electric-powered lubricator including at least the features 1 to 11 and 13, in the case of selecting the second mode, the user can cause the electric-powered lubricator to dispense the set amount of lubricant and the motor to automatically stop only by operating the drive switch. That is, the user does not need to manually stop the motor, and it is possible to dispense an accurate amount of lubricant. Therefore, the convenience and operability of the electric-powered lubricator are further improved.

In one embodiment, in addition to or in place of at least any one of the features 1 to 13, the following feature may be included:
Feature 14: the control circuit estimates a dispensed amount or acquires the dispensed amount measured based on the second mode being selected through the selection switch, the dispensed amount corresponding to an amount of the lubricant dispensed from the dispensing port.

In the electric-powered lubricator including at least the features 1 to 11 and 14, the control circuit can stop the motor in a case where the set amount of lubricant is dispensed by estimating the dispensed amount of lubricant or acquiring the measured dispensed amount.

In one embodiment, in addition to or in place of at least any one of the features 1 to 14, the following features may be included:
Feature 15: the pump includes a chamber configured to communicate with the dispensing port and store the lubricant;
Feature 16: the pump includes a plunger configured to reciprocate within the chamber by the driving force and dispense the lubricant from the dispensing port; and
Feature 17: the control circuit is configured to estimate the dispensed amount based on the number of reciprocations of the plunger within the chamber.

In the electric-powered lubricator including at least the features 1 to 11 and 14 to 17, the control circuit can estimate the dispensed amount of lubricant based on the number of reciprocations of the plunger.

In one embodiment, in addition to or in place of at least any one of the features 1 to 17, the following features may be included:
Feature 18: the first relationship has the variable speed range;
Feature 19: the second relationship has a constant speed range and does not have the variable speed range; and
Feature 20: the constant speed range is defined as a range where the rotational speed is constant regardless of the operation amount.

In the electric-powered lubricator including at least the features 1 to 11 and 18 to 20, in the case of selecting the first mode, the user can adjust the rotational speed of the motor by changing the operation amount of the drive switch. In the electric-powered lubricator including at least the features 1 to 11 and 18 to 20, in the case of selecting the second mode, the user can drive the motor at a constant rotational speed by operating the drive switch. Furthermore, in the second mode, since the second relationship does not have the variable speed range, it is possible to reduce erroneous detection or non-detection of air entrapment.

The air entrapment is a state in which air bubbles are mixed in the lubricant in the pump. When air bubbles are contained in the lubricant, the lubricant is not dispensed from the dispensing port even if the pump is driven by the motor. In a case where the control circuit estimates the dispensed amount of lubricant based on the number of times of driving the pump, the estimation accuracy of the dispensed amount deteriorates due to the erroneous detection or non-detection of the air entrapment. The air entrapment is detected based on the fact that there is no variation in an actual rotational speed of the motor, a motor current, or a motor torque in response to the driving of the pump. During acceleration and deceleration of the motor, it is difficult to determine whether the actual rotational speed of the motor, the motor current, or the motor torque varies in response to the driving of the pump as compared with during constant rotation. Therefore, during acceleration and deceleration of the motor, there is a greater possibility of erroneously detecting or failing to detect the air entrapment as compared with during constant rotation. Since the erroneous detection or non-detection of the air entrapment is reduced in the second mode, the control circuit can estimate the dispensed amount of lubricant with high accuracy.

In one embodiment, in addition to or in place of at least any one of the features 1 to 20, the following features may be included:
Feature 21: the first relationship has a first variable speed range corresponding to the variable speed range;
Feature 22: the second relationship has a constant speed range and a second variable speed range corresponding to the variable speed range;
Feature 23: the constant speed range is defined as a range where the rotational speed is constant regardless of the operation amount; and
Feature 24: a range of the operation amount in the second variable speed range is narrower than a range of the operation amount in the first variable speed range.

In the electric-powered lubricator including at least the features 1 to 11 and 21 to 24, in the case of selecting the first mode, the user can finely adjust the rotational speed of the motor by changing the operation amount of the drive switch in a wide range. In the electric-powered lubricator including at least the features 1 to 11 and 21 to 24, in the case of selecting the second mode, the user can drive the motor at a constant rotational speed by operating the drive switch, and can finely adjust the rotational speed of the motor by changing the operation amount of the drive switch in a narrow range.

In one embodiment, in addition to or in place of at least any one of the features 1 to 24, the following features may be included:
Feature 25: the first relationship has a first variable speed range corresponding to the variable speed range;
Feature 26: the second relationship has a constant speed range and a second variable speed range corresponding to the variable speed range;
Feature 27: the constant speed range is defined as a range where the rotational speed is constant regardless of the operation amount; and
Feature 28: a range of the rotational speed in the second variable speed range is narrower than a range of the rotational speed in the first variable speed range.

In the electric-powered lubricator including at least the features 1 to 11 and 25 to 28, in the case of selecting the first mode, the user can finely adjust the rotational speed of the motor by changing the operation amount of the drive switch in a wide range. In the electric-powered lubricator including at least the features 1 to 11 and 25 to 28, in the case of selecting the second mode, the user can drive the motor at a constant rotational speed by operating the drive switch, and can accelerate or decelerate the motor in a range narrow enough to be able to reduce the erroneous detection or non-detection of the air entrapment.

In one embodiment, in addition to or in place of at least any one of the features 1 to 28, the following features may be included:
Feature 29: the control circuit sets a desired rotational speed of the motor based (i) the actual operation amount of the drive switch manually operated and (ii) the first mode or the second mode selected through the selection switch; and
Feature 30: the control circuit maintains an actual rotational speed of the motor at the desired rotational speed.

According to the electric-powered lubricator including at least the features 1 to 11 and 29 to 30, the user can adjust the actual rotational speed of the motor according to the selected operation mode.

In one embodiment, in addition to or in place of at least any one of the features 1 to 30, the following feature may be included:
Feature 31: the control circuit changes the operation mode during stop of the motor based on manual operation of the selection switch by the user.

According to the electric-powered lubricator including at least the features 1 to 11 and 31, it is possible to reduce switching of the operation mode not intended by the user and to safely switch the operation mode.

In one embodiment, in addition to or in place of at least any one of the features 1 to 31, the following feature may be included:
Feature 32: the set amount corresponds to the number of dispensing times set by the user.

According to the electric-powered lubricator including at least the features 1 to 11, 13, and 32, the user can set the dispensed amount of lubricant by setting the number of times of dispensing the lubricant.

One embodiment may provide a method of controlling of a lubricant from an electric-powered lubricator (or an electric oil syringe or an electric grease gun) including at least any one of:
Feature 33: setting a first mode or a second mode as an operation mode of the electric-powered lubricator based on manual operation of a selection switch of the electric-powered lubricator by a user;
Feature 34: the first mode associates an operation amount of a drive switch of the electric-powered lubricator with a rotational speed of a motor in a first relationship;
Feature 35: the motor is configured to drive a pump of the electric-powered lubricator;
Feature 36: the second mode associates the operation amount with the rotational speed in a second relationship different from the first relationship;
Feature 37: a variable speed range in the first relationship is wider than a variable speed range in the second relationship,
Feature 38: the variable speed range is defined as a range where the rotational speed changes according to the operation amount;
Feature 39: controlling the motor based on (i) an actual operation amount of the drive switch and (ii) the operation mode set through the selection switch based on manual operation of the drive switch by the user.

According to the method including at least Features 33 through 39, the same effects as the electric-powered lubricator including at least the features 1 to 11 are obtained.

In one embodiment, the features 1 to 39 described above may be combined in any combination.

In one embodiment, any of the features 1 to 39 described above may be excluded.

### Specific Exemplary Embodiments

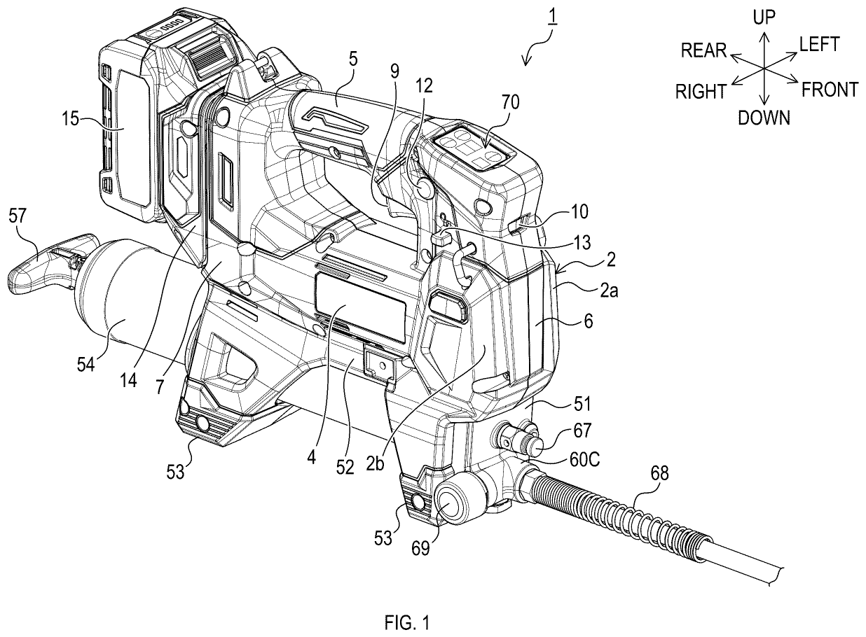

The following example embodiments provide an electric-powered lubricator 1 illustrated in FIG. 1. The electric-powered lubricator 1 is an electric grease gun configured to dispense a semi-solid lubricant, more specifically, grease.

For convenience of description, directions in the electric-powered lubricator 1 are defined as appropriately illustrated in FIG. 1 and the subsequent drawings. Specifically, “up” (upward direction), “down” (downward direction), “right” (rightward direction), “left” (leftward direction), “front” (forward direction), and “rear” (backward direction) are defined.

### 1. First Embodiment

### 1-1. Configuration

### 1-1-1. Mechanical Configuration of Electric-Powered Lubricator

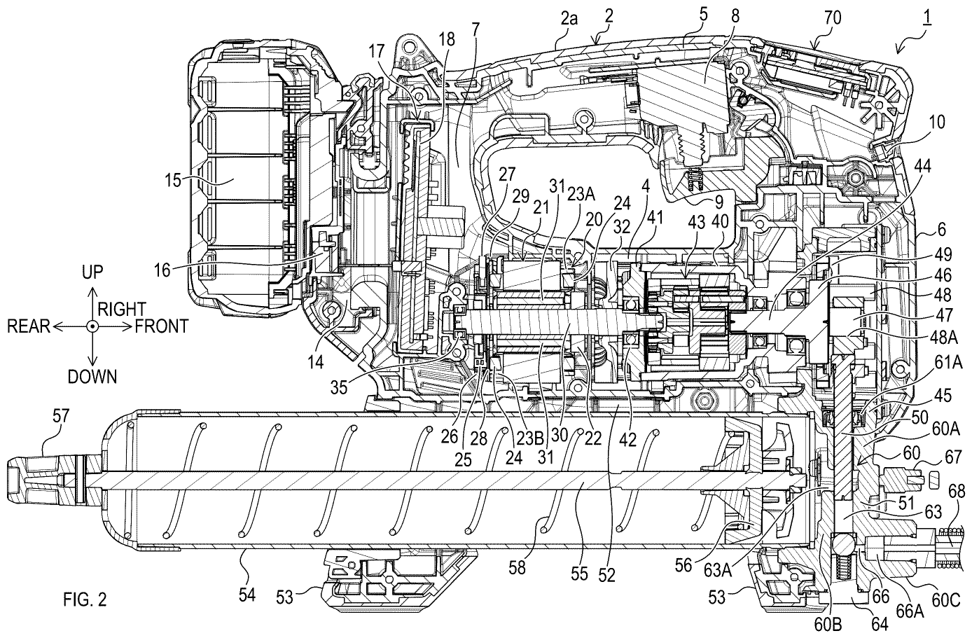

As illustrated in FIGS. 1 and 2, the electric-powered lubricator 1 includes a housing 2. The housing 2 includes a first half housing 2a and a second half housing 2b joined to each other.

The housing 2 includes a motor housing portion 4 at its central portion in a height direction. The height direction corresponds to a direction from the lower side to the upper side or from the upper side to the lower side of the housing 2. In the first embodiment, the motor housing portion 4 has a cylindrical shape and extends in a length direction. The length direction corresponds to a direction from the front side to the rear side or from the rear side to the front side of the housing 2. The motor housing portion 4 houses an electric motor (hereinafter, abbreviated as “motor”) 20.

The housing 2 includes a grip 5 at its upper portion. In the first embodiment, the grip 5 extends in the length direction and is bent downward. The motor housing portion 4 includes a front coupling portion 6 at its front end. The front coupling portion 6 is coupled to a front end of the grip 5. The motor housing portion 4 includes a rear coupling portion 7 at its rear end. The rear coupling portion 7 is coupled to a rear end of the grip 5. In the first embodiment, the rear coupling portion 7 rises upward so as to form a space between the motor housing portion 4 and the grip 5.

The electric-powered lubricator 1 includes a trigger switch 8 housed in the grip 5. The electric-powered lubricator 1 includes a trigger 9 for a user of the electric-powered lubricator 1 to manually operate the trigger switch 8.

The trigger 9 is pulled by the user to drive the motor 20 (that is, to dispense grease). The trigger 9 is configured to be displaceable between an initial position and a maximum position. In a case where the trigger 9 is not manually operated, the trigger 9 is located at the initial position. In response to the manual operation of the trigger 9, the trigger 9 moves from the initial position toward the maximum position.

In a case where the trigger 9 is located between the initial position and a minimum position, the trigger switch 8 is off, and the motor 20 is stopped. The minimum position is located between the initial position and the maximum position. In a case where the trigger 9 is located between the minimum position and the maximum position, the trigger switch 8 is on, and the motor 20 is rotatable. In the first embodiment, the trigger 9 protrudes downward from the grip 5.

The grip 5 includes a light 10 on its front surface. In the first embodiment, the light 10 includes a light-emitting diode (LED) (not illustrated) as a light source. The grip 5 includes an operation panel 70 on its front upper surface. The operation panel 70 is configured to be manually operated by the user to turn on or off the light 10 or to change the settings of the electric-powered lubricator 1.

The grip 5 includes a first lock button 12 in front of the trigger 9. The first lock button 12 is configured to be pressed down by the user to lock the trigger 9 in the maximum position. The grip 5 includes a second lock button 13 below the first lock button 12. The second lock button 13 is configured to be pressed down by the user to lock the trigger 9 in the initial position (that is, a position not pulled).

The rear coupling portion 7 includes a battery holding portion 14 at its rear end. The battery holding portion 14 is configured such that a battery pack 15 is detachably attached. In the first embodiment, the battery pack 15 is attached to the battery holding portion 14 by being slid from the upper side to the lower side at a rear end of the battery holding portion 14. In the first embodiment, the battery pack 15 has a rated voltage of 36 V, but the rated voltage of the battery pack 15 is not limited to 36 V, and may be any value.

The battery holding portion 14 includes a terminal block 16 therein. The terminal block 16 is configured to be electrically connected to the battery pack 15 attached to the battery holding portion 14. In the first embodiment, the terminal block 16 extends in the height direction.

The battery holding portion 14 houses a control unit 17 in front of the terminal block 16. In the first embodiment, the control unit 17 extends in the height direction. The control unit 17 includes a control circuit board 18.

In the first embodiment, the motor 20 is an inner rotor-type brushless motor (specifically, a three-phase brushless DC motor). In another embodiment, the motor 20 may be any other types of motors (for example, a DC motor with brush). Specifically, the motor 20 may be a single-phase brushless DC motor, a two-phase brushless DC motor, a four-phase or more brushless DC motor, a motor with brush, an AC motor, or a stepping motor.

The motor 20 includes a stator 21. The stator 21 includes three lead wires 27. FIG. 2 illustrates only one lead wire 27. The stator 21 includes a first insulator 23A at its front end. The stator 21 includes a second insulator 23B at its rear end.

The stator 21 includes three coils 24 wound with the first insulator 23A and the second insulator 23B interposed therebetween. The second insulator 23B includes six terminals (not illustrated). The six terminals are fused to respective end portions of the three coils 24.

The second insulator 23B includes a short-circuiting member 25. The short-circuiting member 25 includes three short-circuiting fittings 26 formed by insert molding. FIG. 2 illustrates only two short-circuiting fittings 26. These short-circuiting fittings 26 electrically connect the above-described terminals of the second insulator 23B such that the above-described coils 24 form a delta configuration (or a delta connection). The above-described coils 24 may form a star configuration (or a star connection).

The stator 21 includes a sensor circuit board 28 between the second insulator 23B and the short-circuiting member 25. The sensor circuit board 28 includes first to third rotational position sensors. In the first embodiment, the first to third rotational position sensors are Hall sensors, but are not limited to the Hall sensors. The first to third rotational position sensors are connected to three signal wires 29. FIG. 2 illustrates only one signal wire 29. The lead wires 27 and the signal wires 29 are connected to the control circuit board 18 of the control unit 17.

The motor 20 includes a rotor 22 inside the stator 21. The rotor 22 includes a rotation shaft 30 at its center. The rotation shaft 30 includes two or more permanent magnets 31 embedded in an outer circumferential wall of the rotation shaft 30.

The first to third rotational position sensors are (i) disposed around the rotor 22, to (ii) detect a rotational position of the rotation shaft 30, and thereby, a rotational position of the rotor 22. The rotation shaft 30 includes a fan 32 attached to its front end. In the first embodiment, the fan 32 extends orthogonal to the rotation shaft 30.

The rear coupling portion 7 houses a first bearing 35 behind the short-circuiting member 25. The first bearing 35 rotatably supports a rear end of the rotation shaft 30. The motor housing portion 4 includes a gear housing 40 in front of the motor 20. In the first embodiment, the gear housing 40 has a cylindrical shape. The gear housing 40 has an opening at its rear end. The gear housing 40 includes a bracket plate 41 attached to the opening. The rotation shaft 30 passes through the bracket plate 41 and protrudes into the gear housing 40. The bracket plate 41 holds a second bearing 42. The second bearing 42 rotatably supports the front end of the rotation shaft 30.

The gear housing 40 includes a spindle 44 at its front end. The gear housing 40 houses a speed reduction mechanism 43. The speed reduction mechanism 43 is configured to (i) receive rotation of the rotation shaft 30 and (ii) rotate the spindle 44 at a rotational speed lower than a rotational speed of the rotation shaft 30. The speed reduction mechanism 43 may include a planetary gear.

The housing 2 includes a crank housing 45 at the front end of the gear housing 40. In the first embodiment, the crank housing 45 extends in the height direction. The spindle 44 protrudes from the gear housing 40 into the crank housing 45.

The crank housing 45 houses a crank disk 46 provided at a front end of the spindle 44. The crank disk 46 includes an eccentric pin 47 protruding forward. The crank housing 45 includes a slider 48 in front of the crank disk 46. The slider 48 has a long hole 48A extending in a width direction. The width direction corresponds to a direction from the right side to the left side or from the left side to the right side of the housing 2. The eccentric pin 47 is inserted into the long hole 48A. The slider 48 is coupled to a plunger 50 at its lower end center. The plunger 50 has an upper end coupled to the slider 48 and extends downward.

The crank housing 45 includes a slider guide 49 that vertically movably supports the slider 48. The slider 48 is movable in the height direction along the slider guide 49.

In the crank housing 45 configured as described above, when the crank disk 46 rotates together with the spindle 44, the eccentric pin 47 moves eccentrically. The slider 48 reciprocates up and down by a stroke in the height direction of the eccentric pin 47, and the plunger 50 also reciprocates up and down.

The crank housing 45 includes a front holder 51 at its lower portion. The housing 2 includes a rear holder 52 behind the front holder 51 and below the motor housing portion 4. The rear holder 52 includes two leg portions 53 protruding downward at its front end and its rear end.

The electric-powered lubricator 1 includes a tank 54 supported by the front holder 51 and the rear holder 52. The tank 54 includes an open front end. The tank 54 reaches a rear surface of the front holder 51 through the rear holder 52. The front end of the tank 54 is screwed to the rear surface of the front holder 51. That is, the tank 54 extends in the length direction below the motor housing portion 4.

The tank 54 houses a rod 55. The rod 55 extends from a rear end of the tank 54 to the front end of the tank 54. The rod 55 movably holds a piston 56 along the rod 55. The rod 55 has a rear end protruding from the tank 54. The tank 54 includes a handle 57 attached to the rear end of the rod 55. The tank 54 houses a coil spring 58. The coil spring 58 is behind the piston 56 and biases the piston 56 forward. The tank 54 houses a cartridge (not illustrated) filled with grease in front of the piston 56. This cartridge is pressed by the piston 56 to supply the grease into the front holder 51.

The front holder 51 includes a pump 60. The pump 60 includes the plunger 50 described above. The pump 60 includes an upper cylindrical portion 60A and a lower cylindrical portion 60B. The upper cylindrical portion 60A and the lower cylindrical portion 60B form a chamber 63. The plunger 50 is in the chamber 63.

The chamber 63 includes an inflow hole 63A between the upper cylindrical portion 60A and the lower cylindrical portion 60B. The chamber 63 communicates with the tank 54 through the inflow hole 63A. The grease is supplied from the cartridge into the chamber 63 through the inflow hole 63A.

The upper cylindrical portion 60A includes a seal ring 61A at its upper portion. The plunger 50 passes through the seal ring 61A. The seal ring 61A prevents or reduces leakage of the grease in the chamber 63 to the upper side from the upper cylindrical portion 60A.

The lower cylindrical portion 60B includes a dispensing path 66. The dispensing path 66 (i) communicates with the chamber 63 through a check valve 64 to be described later, and (ii) extends in the length direction. The front holder 51 includes a front cylindrical portion 60C at its front end. The front cylindrical portion 60C protrudes forward from the front holder 51. The dispensing path 66 passes through the center of the front cylindrical portion 60C. The dispensing path 66 includes a dispensing port 66A at its front end. The front cylindrical portion 60C is connected to a hose 68. The grease is dispensed from the dispensing port 66A to the outside of the electric-powered lubricator 1 through the hose 68.

The pump 60 includes the aforementioned check valve 64 in a lower portion of the chamber 63. The check valve 64 allows the grease to flow out from the chamber 63 to the dispensing path 66, and reduces or prevents a backflow of the grease from the dispensing path 66 to the chamber 63.

The front cylindrical portion 60C includes a relief valve 69 at its right side portion. The relief valve 69 is configured to release the grease in the dispensing path 66 to the outside of the electric-powered lubricator 1 in response to the pressure of the grease in the dispensing path 66 becoming equal to or more than a predetermined pressure.

The front holder 51 includes an air drain valve 67 at its front end. The air drain valve 67 is provided to release gas (for example, air) in the chamber 63 (specifically, near the inflow hole 63A) to the outside of the electric-powered lubricator 1. When the air drain valve 67 is tightened, the chamber 63 is shut off from the outside of the electric-powered lubricator 1. The electric-powered lubricator 1 is usually used in a state where the air drain valve 67 is tightened. When the air drain valve 67 is loosened, the chamber 63 communicates with the outside of the electric-powered lubricator 1. At this time, gas in the chamber 63, if any, can be released to the outside of the electric-powered lubricator 1 through the air drain valve 67.

In the electric-powered lubricator 1 configured as described above, when the user pulls the trigger 9, the motor 20 rotates, and thereby, the rotation shaft 30 rotates. The rotation of the rotation shaft 30 is transmitted to the spindle 44 through the speed reduction mechanism 43, and the crank disk 46 rotates together with the spindle 44. As a result, the eccentric pin 47 moves eccentrically. In response to the eccentric movement of the eccentric pin 47, (i) the slider 48 moves up and down along the slider guide 49, so that (ii) the plunger 50 reciprocates up and down. Therefore, the plunger 50 dispenses the grease at a speed corresponding to a rotational speed of the motor 20.

### 1-1-2. Configuration of Operation Panel

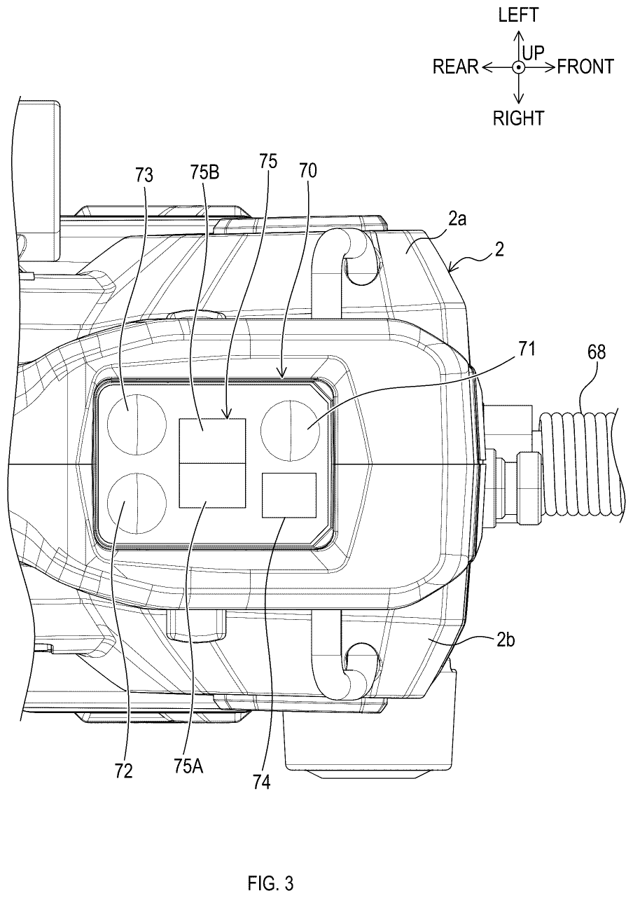

As illustrated in FIG. 3, the operation panel 70 includes a first switch 71. In the first embodiment, the first switch 71 and second and third switches 72 and 73 to be described later are push-button switches. In another embodiment, the first to third switches 71 to 73 may be other types of manual switches.

Every time the first switch 71 is pressed for a short time, the level of the number of rotations (that is, the rotational speed) of the motor 20 is sequentially switched to one of a plurality of levels (for example, four levels). The motor 20 rotates at an actual rotational speed corresponding to the rotational speed level set by the first switch 71.

When the first switch 71 is pressed for a long time, the light 10 is turned on. After the light 10 is turned on, the light 10 may be turned off (i) with the lapse of a predetermined length of time or (ii) in a case where the first switch 71 is pressed for a long time again, for example. Pressing the switch for a short time corresponds to an operation of releasing the switch before the lapse of a certain length of time from the start of pressing. Pressing the switch for a long time corresponds to an operation of releasing the switch after the pressing continues for the certain length of time or more.

The operation panel 70 includes a first display 74. The first display 74 displays the set rotational speed level (for example, any one of “1” to “4”). In the first embodiment, each of the first display 74 and second and third display 75A and 75B to be described later is a 7-segment display. In another embodiment, each of the first to third display 74, 75A, and 75B may be other types of display including a liquid crystal display (LCD).

The operation panel 70 includes the second switch 72 and the third switch 73 described above. Every time the second and third switches 72 and 73 are simultaneously pressed, the operation mode of the electric-powered lubricator 1 is switched. In the first embodiment, the operation mode is a continuous dispensing mode or an automatic dispensing mode (or a quantitative dispensing mode). Hereinafter, the continuous dispensing mode is referred to as a first mode, and the automatic dispensing mode is referred to as a second mode. In the first embodiment, every time the second and third switches 72 and 73 are simultaneously pressed, the operation mode is alternately switched to the first mode or the second mode. In another embodiment, every time the second switch 72 or the third switch 73 is pressed for a long time, the operation mode may be alternately switched to the first mode or the second mode.

In the first mode, while the trigger 9 is being pulled, the motor 20 continuously rotates at a set desired rotational speed.

In the second mode, the rotation of the motor 20 is started in response to the pulling of the trigger 9. When the plunger 50 (in other words, the slider 48) reciprocates a set number of reciprocations after the start of rotation (in other words, when a set amount of grease is dispensed), the motor 20 is automatically stopped even if the trigger 9 is being pulled. The set number of reciprocations corresponds to the number of times of dispensing the grease, and can be set to any value by the user.

The operation panel 70 includes a set number display 75. The set number display 75 includes the second display 75A and the third display 75B described above. When the first mode is set as the operation mode, the set number display 75 displays a symbol or the like indicating the first mode. When the second mode is set as the operation mode, the set number display 75 displays the set number of reciprocations.

In the first embodiment, in the second mode, any set number of reciprocations can be set with a predetermined maximum set number of 99 times or less as an upper limit. The amount of grease dispensed from the dispensing port 66A in one reciprocation is predetermined depending on the structure of the pump 60. Therefore, the user setting the set number of reciprocations corresponds to setting the number of times of dispensing the grease, and thereby, a dispensed amount. The user can set the set number of reciprocations to any value by operating the second switch 72 or the third switch 73. Specifically, in the second mode, every time the second switch 72 is pressed, the set number of reciprocations is increased by one, and the increased set number of reciprocations is displayed on the set number display 75. On the contrary, in the second mode, every time the third switch 73 is pressed, the set number of reciprocations is decreased by one, and the decreased set number of reciprocations is displayed on the set number display 75. The maximum set number may be determined in any manner, and may be set to 100 times or more. In another embodiment, the electric-powered lubricator 1 may be configured such that the dispensed amount can be set using another user interface in the second mode. The user interface may be the operation panel 70 or a voice input interface that can be added to the electric-powered lubricator 1.

### 1-1-3. Electrical Configuration of Electric-Powered Lubricator

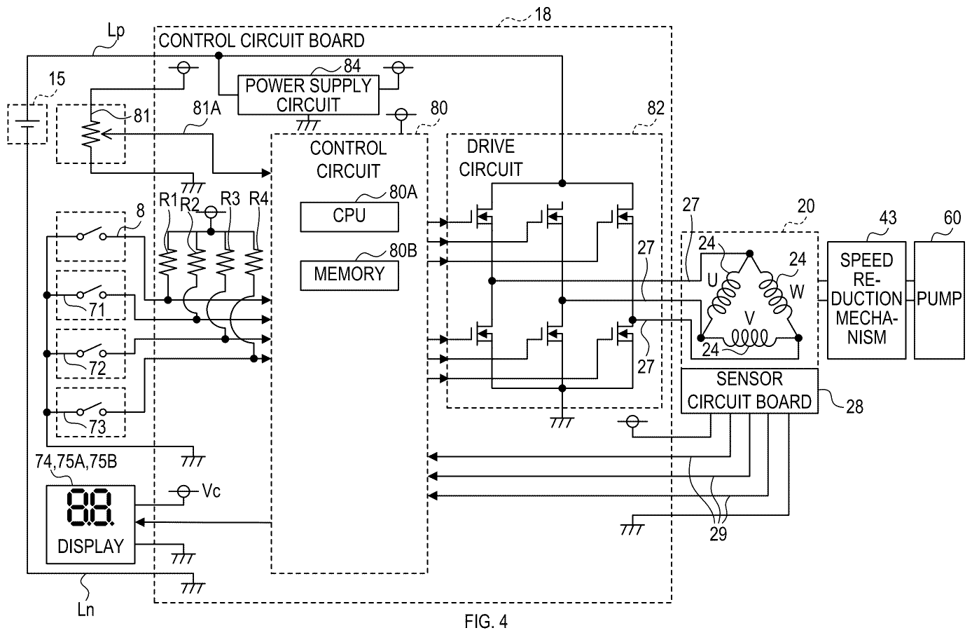

An electrical configuration of the electric-powered lubricator 1 will be described with reference to FIG. 4. The electric-powered lubricator 1 includes the control circuit board 18 having the ground. The electric-powered lubricator 1 includes a power supply line Lp extending from a positive electrode of the battery pack 15 attached to the battery holding portion 14 onto the control circuit board 18. The electric-powered lubricator 1 includes a ground line Ln extending from a negative electrode of the battery pack 15 attached to the battery holding portion 14 to the ground on the control circuit board 18. The battery pack 15 applies its rated voltage between the power supply line Lp and the ground line Ln.

The electric-powered lubricator 1 includes a power supply circuit 84. In the first embodiment, the power supply circuit 84 is on the control circuit board 18. The power supply circuit 84 is connected to the power supply line Lp and the ground. The power supply circuit 84 generates a fixed direct current voltage (hereinafter, referred to as power supply voltage) Vc on the basis of the rated voltage of the battery pack 15.

The electric-powered lubricator 1 includes a control circuit 80. The control circuit 80 is on the control circuit board 18 and operates by receiving the power supply voltage Vc. The control circuit 80 is a microcomputer including a CPU 80A and a semiconductor memory 80B. The semiconductor memory 80B includes a ROM, a RAM, and a rewritable non-volatile memory. The non-volatile memory is, for example, an EEPROM, a flash memory, a ReRAM, a FeRAM, or the like. Various functions of the control circuit 80 are implemented by the CPU 80A executing a program stored in the semiconductor memory 80B. When the CPU 80A executes this program, a method corresponding to this program is executed.

In another embodiment, the control circuit 80 may include an additional microcomputer. In still another embodiment, some or all of the functions achieved by the CPU 80A may be achieved in one or more electronic components (for example, an integrated circuit). In yet another embodiment, the control circuit 80 may be a logic circuit (alternatively, a wired logic connection) that includes two or more electronic components. In still another embodiment, the control circuit 80 may include an application-specific integrated circuit (ASIC) and/or an application-specific standard product (ASSP). In yet another embodiment, the control circuit 80 may include a programmable logic device on which a reconstructable logic circuit can be constructed. Examples of the programmable logic device include a field-programmable gate array (FPGA).

The electric-powered lubricator 1 includes a drive circuit 82 configured to drive the motor 20. In the first embodiment, the drive circuit 82 is on the control circuit board 18. The drive circuit 82 is a three-phase full-bridge circuit, but is not limited to the three-phase full-bridge circuit. In another embodiment, the drive circuit 82 may be a full-bridge circuit having a single phase, two phases, or four or more phases, or may be a half-bridge circuit. The drive circuit 82 includes first to third semiconductor switches Q1 to Q3 disposed on the high side and fourth to sixth semiconductor switches Q4 to Q6 disposed on the low side. The first to third semiconductor switches Q1 to Q3 are connected to the power supply line Lp and the lead wires 27 of the motor 20, and function as so-called high-side switches. The fourth to sixth semiconductor switches Q4 to Q6 are connected to the lead wires 27 and the ground, and function as so-called low-side switches.

The first to sixth semiconductor switches Q1 to Q6 receive first to sixth drive control signals from the control circuit 80, respectively, and are turned on or off according to the respective received drive control signals. In the first embodiment, the first to sixth drive control signals are pulse width modulation (hereinafter, PWM) signals. Examples of the semiconductor switch include a metal-oxide-semiconductor field-effect transistor (MOSFET), a junction field-effect transistor (JFET), a bipolar transistor, an insulated gate bipolar transistor (IGBT), a solid state relay (SSR), and a thyristor.

The electric-powered lubricator 1 includes a slide resistor 81 having a lever 81A. The lever 81A has a displaceable first end and a second end connected to the control circuit 80. The slide resistor 81 has a resistance value that changes according to the position of the first end of the lever 81A. The second end of the lever 81A outputs a signal having a voltage of a magnitude corresponding to the resistance value to the control circuit 80. The first end of the lever 81A is displaced according to the position of the trigger 9 in a range from the initial position to the maximum position. For example, the resistance value of the slide resistor 81 is smallest when the trigger 9 is located at the initial position, and increases as the trigger 9 approaches the maximum position from the initial position.

The electric-powered lubricator 1 includes first to fourth pull-up resistors R1 to R4. In the first embodiment, the first to fourth pull-up resistors R1 to R4 are on the control circuit board 18. Each of the first to fourth pull-up resistors R1 to R4 has a first end connected to the power supply circuit 84 so as to receive the power supply voltage Vc from the power supply circuit 84. The first pull-up resistor R1 has a second end connected to a first end of the trigger switch 8 and the control circuit 80. The second pull-up resistor R2 has a second end connected to a first end of the first switch 71 and the control circuit 80. The third pull-up resistor R3 has a second end connected to a first end of the second switch 72 and the control circuit 80. The fourth pull-up resistor R4 has a second end connected to a first end of the third switch 73 and the control circuit 80. Each of the trigger switch 8, the first switch 71, the second switch 72, and the third switch 73 has a second end connected to the ground on the control circuit board 18.

In a case where the trigger switch 8, the first switch 71, the second switch 72, and the third switch 73 are off, the second ends of the first to fourth pull-up resistors R1 to R4 have voltages of the same level (that is, a high level) as the power supply voltage Vc. In a case where the trigger switch 8, the first switch 71, the second switch 72, and the third switch 73 are on, the second ends of the first to fourth pull-up resistors R1 to R4 have voltages of the same level (that is, a low level) as the ground. The first to fourth pull-up resistors R1 to R4 may have the same resistance value as each other or different resistance values from each other.

The control circuit 80 can detect whether the trigger 9, the first switch 71, the second switch 72, and the third switch 73 are being manually operated on the basis of the voltages at the second ends of the first to fourth pull-up resistors R1 to R4. Specifically, in a case where the voltages at the second ends of the first to fourth pull-up resistors R1 to R4 are at a high level, the control circuit 80 detects that the trigger 9, the first switch 71, the second switch 72, and the third switch 73 are not being manually operated. In a case where the voltages at the second ends of the first to fourth pull-up resistors R1 to R4 are at a low level, the control circuit 80 detects that the trigger 9, the first switch 71, the second switch 72, and the third switch 73 are being manually operated.

The control circuit board 18 is connected to the first to third display 74, 75A, and 75B of the operation panel 70. The first to third display 74, 75A, and 75B operate by receiving the power supply voltage Vc from the control circuit board 18. The first to third display 74, 75A, and 75B also receive first to third display control signals from the control circuit 80, respectively, and display information.

The control circuit board 18 is connected to the sensor circuit board 28. The first to third rotational position sensors on the sensor circuit board 28 operate by receiving the power supply voltage Vc from the control circuit board 18. The first to third rotational position sensors are connected to the control circuit 80 through the signal wires 29, and output first to third rotation signals to the control circuit 80. The first to third rotation signals are associated with three phases (that is, U phase, V phase, and W phase) of the motor 20, respectively. The first to third rotation signals are sinusoidal signals, and the respective voltages are inverted from positive to negative or from negative to positive every time the rotor 22 rotates by an electric angle of 180 degrees. The first to third rotation signals have a phase difference of an electric angle of 120 degrees with each other.

In another embodiment, the sensor circuit board 28 may be configured to output, instead of the first to third rotation signals, a rotation detection signal (for example, a pulse signal) to the control circuit 80 every time the rotor 22 rotates by an electric angle of 60 degrees.

### 1-1-4. Functional Configuration of Electric-Powered Lubricator

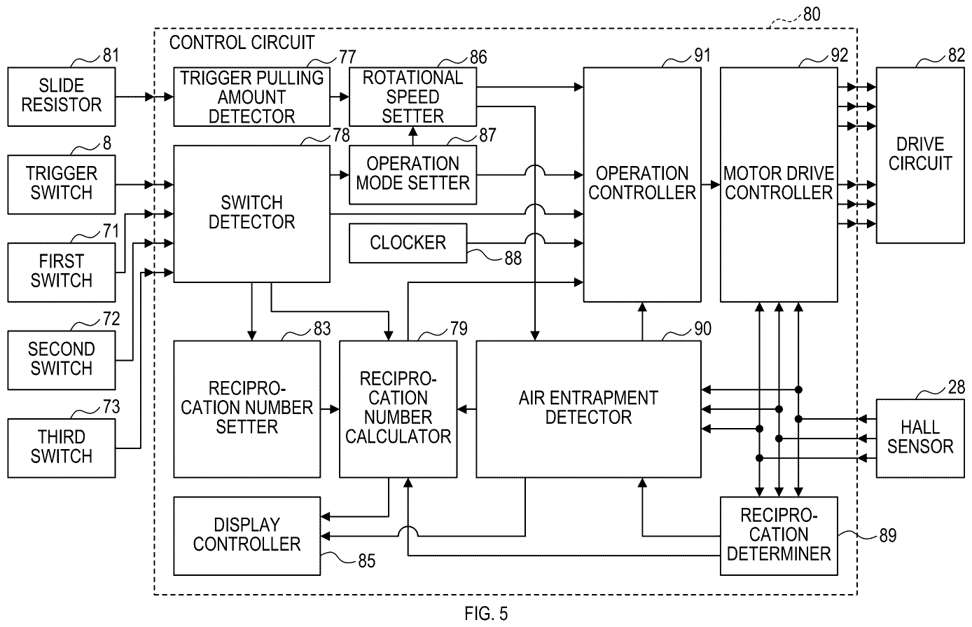

The functions of the control circuit 80 will be described with reference to FIG. 5. The control circuit 80 has the functions of a trigger pulling amount detector 77, a switch detector 78, a reciprocation number setter 83, a reciprocation number calculator 79, a display controller 85, a rotational speed setter 86, an operation mode setter 87, a clocker 88, a reciprocation determiner 89, an air entrapment detector 90, an operation controller 91, and a motor drive controller 92. In the first embodiment, these functions are incorporated in the control circuit 80 by software.

In another embodiment, at least one of the functions of the trigger pulling amount detector 77, the switch detector 78, the reciprocation number setter 83, the reciprocation number calculator 79, the display controller 85, the rotational speed setter 86, the operation mode setter 87, the clocker 88, the reciprocation determiner 89, the air entrapment detector 90, the operation controller 91, and the motor drive controller 92 may be incorporated in the control circuit 80 by hardware (electronic circuit) instead of software. In yet another embodiment, at least one of the functions of the trigger pulling amount detector 77, the switch detector 78, the reciprocation number setter 83, the reciprocation number calculator 79, the display controller 85, the rotational speed setter 86, the operation mode setter 87, the clocker 88, the reciprocation determiner 89, the air entrapment detector 90, the operation controller 91, and the motor drive controller 92 may be removed.

The trigger pulling amount detector 77 detects an actual pulling amount of the trigger 9 on the basis of the voltage input from the slide resistor 81. Specifically, in a case where the voltage corresponds to the initial position of the trigger 9, the trigger pulling amount detector 77 detects zero. In a case where the voltage corresponds to the maximum position of the trigger 9, the trigger pulling amount detector 77 detects a maximum amount. In a case where the voltage corresponds to an intermediate position of the trigger 9, the trigger pulling amount detector 77 detects an actual pulling amount between zero and the maximum value. The intermediate position is between the initial position and the maximum position. The trigger pulling amount detector 77 outputs the detected actual pulling amount to the rotational speed setter 86.

The switch detector 78 detects changes from off to on and from on to off of the trigger switch 8, the first switch 71, the second switch 72, and the third switch 73. The switch detector 78 outputs a first signal and a second signal to the operation controller 91, and outputs a third signal and a fourth signal to the operation mode setter 87. The switch detector 78 also outputs the first signal to the reciprocation number calculator 79. The first signal indicates a change of the trigger switch 8 from off to on, and the second signal indicates a change of the trigger switch 8 from on to off. The third signal indicates a change of the first switch 71 from off to on. The fourth signal indicates simultaneous or substantially simultaneous changes of the second switch 72 and the third switch 73 from off to on.

Furthermore, the switch detector 78 detects the number of times N the second switch 72 changes from off to on within a predetermined period after detecting simultaneous or substantially simultaneous changes of the second switch 72 and the third switch 73 from on to off. The switch detector 78 also detects the number of times M the third switch 73 changes from off to on within the predetermined period after detecting the simultaneous or substantially simultaneous changes of the second switch 72 and the third switch 73 from on to off. The switch detector 78 outputs the detected numbers of times N and M to the reciprocation number setter 83.

The operation mode setter 87 sets the rotational speed level of the motor 20 according to the input third signal. For example, in a case where the rotational speed level includes first to fourth levels, the operation mode setter 87 changes the rotational speed levels in the order of the first level→the second level→the third level→the fourth level every time the third signal is input.

The operation mode setter 87 sets the first mode or the second mode as the operation mode of the electric-powered lubricator 1 according to the input fourth signal. Specifically, every time the fourth signal is input, the operation mode setter 87 switches the operation mode from the first mode to the second mode or from the second mode to the first mode. The operation mode setter 87 outputs the set rotational speed level and the set operation mode to the operation controller 91. The operation mode setter 87 outputs the set operation mode to the rotational speed setter 86. The operation mode setter 87 also outputs the set rotational speed level to the display controller 85 (the arrow is omitted in FIG. 5).

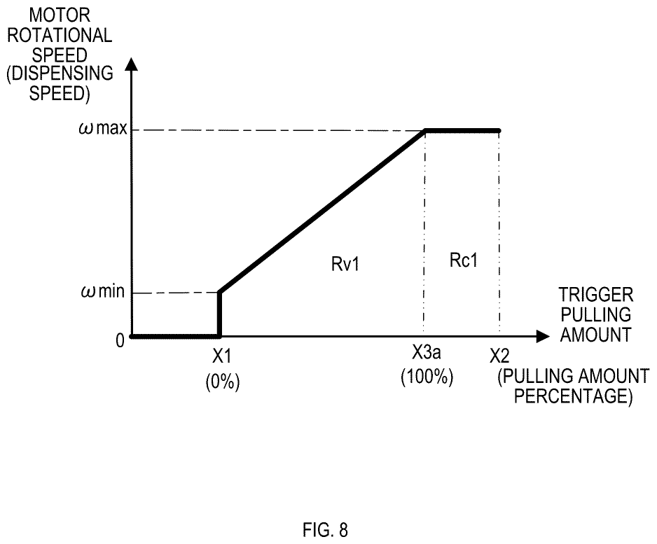

The rotational speed setter 86 sets a desired rotational speed of the motor 20 on the basis of the input actual pulling amount and the input operation mode. The actual rotational speed of the motor 20 is proportional to a dispensing speed. The dispensing speed is a speed at which the grease is dispensed from the dispensing port 66A. Specifically, in a case where the operation mode is the first mode, the rotational speed setter 86 sets the desired rotational speed on the basis of the input actual pulling amount and a first relationship illustrated in FIG. 8. The first relationship associates the pulling amount of the trigger 9 with the rotational speed of the motor 20. That is, the first relationship corresponds to a function of the rotational speed with respect to the pulling amount. The rotational speed setter 86 sets the rotational speed associated with the actual pulling amount in the first relationship as the desired rotational speed.

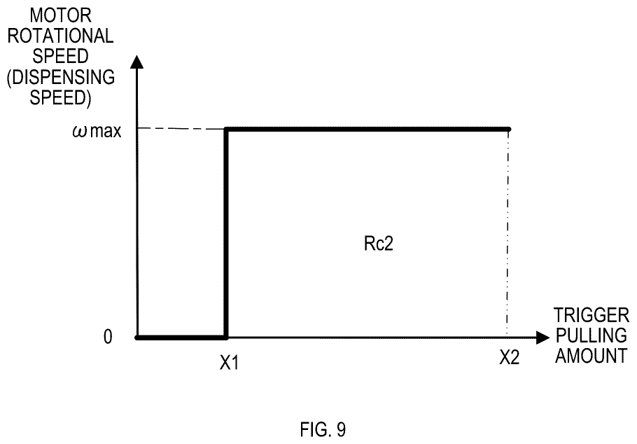

In a case where the operation mode is the second mode, the rotational speed setter 86 sets the desired rotational speed on the basis of the input actual pulling amount and a second relationship illustrated in FIG. 9. The second relationship is different from the first relationship, and associates the pulling amount of the trigger 9 with the rotational speed of the motor 20. That is, the second relationship corresponds to a function of the rotational speed with respect to the pulling amount, the function being different from that of the first relationship. The rotational speed setter 86 sets the rotational speed associated with the actual pulling amount in the second relationship as the desired rotational speed. The rotational speed setter 86 outputs the set desired rotational speed to the operation controller 91 and the air entrapment detector 90. Details of the setting of the desired rotational speed by the rotational speed setter 86 will be described later.

The clocker 88 counts every one cycle of a clock. For example, in a case where the clock has a frequency of 1 Hz, the clocker 88 counts every 1 second and outputs the count value to the operation controller 91.

In a case where the second mode is set as the operation mode, the reciprocation number setter 83 calculates the set number of reciprocations of the plunger 50 on the basis of the input number of times N and the input number of times M. Specifically, the reciprocation number setter 83 calculates N×10+M times as the set number of reciprocations. The reciprocation number setter 83 outputs the set number of reciprocations to the reciprocation number calculator 79.

The reciprocation determiner 89 receives the first to third rotation signals from the first to third rotational position sensors. The reciprocation determiner 89 counts the number of rotations of the motor 20 on the basis of the first to third rotation signals. The reciprocation determiner 89 determines whether the plunger 50 has reciprocated once on the basis of the number of rotations of the motor 20 and a speed reduction ratio of the speed reduction mechanism 43. When determining that the plunger 50 has reciprocated once, the reciprocation determiner 89 outputs a reciprocation determination signal to the reciprocation number calculator 79 and the air entrapment detector 90.

The air entrapment detector 90 detects air entrapment of the grease. The air entrapment is a state in which air bubbles are mixed in the grease in the chamber 63. When air bubbles are contained in the chamber 63, the grease is not dispensed from the dispensing port 66A even if the plunger 50 reciprocates. Therefore, when the number of reciprocations of the plunger 50 is calculated without considering the air entrapment, the number of reciprocations of the plunger 50 does not coincide with the number of times of dispensing the grease. As a result, the number of reciprocations of the plunger 50 does not correspond to the dispensed amount of grease. The air entrapment detector 90 detects the air entrapment so as to make the number of reciprocations of the plunger 50 correspond to the dispensed amount of grease.

A load corresponding to the dispensed amount of grease is applied to the motor 20. Therefore, in a case where the grease is dispensed from the dispensing port 66A, the actual rotational speed of the motor 20, a motor current flowing through the motor 20, and a motor torque vary in response to one reciprocation (that is, the grease being dispensed once) of the plunger 50. Specifically, the actual rotational speed is minimized in response to one reciprocation of the plunger 50. The motor current and the motor torque are maximized in response to one reciprocation of the plunger. On the other hand, in a case where the grease is not dispensed from the dispensing port 66A, the actual rotational speed, the motor current, and the motor torque do not vary in response to one reciprocation of the plunger 50. Therefore, in the case of receiving the reciprocation determination signal from the reciprocation determiner 89, the air entrapment detector 90 detects the air entrapment on the basis of the fact that there is no minimized actual rotational speed corresponding to the reciprocation determination signal. Alternatively, the air entrapment detector 90 detects the air entrapment on the basis of the fact that there is no maximized motor current or motor torque corresponding to the reciprocation determination signal. In the case of detecting the air entrapment, the air entrapment detector 90 outputs an air entrapment detection signal to the reciprocation number calculator 79, the operation controller 91, and the display controller 85.

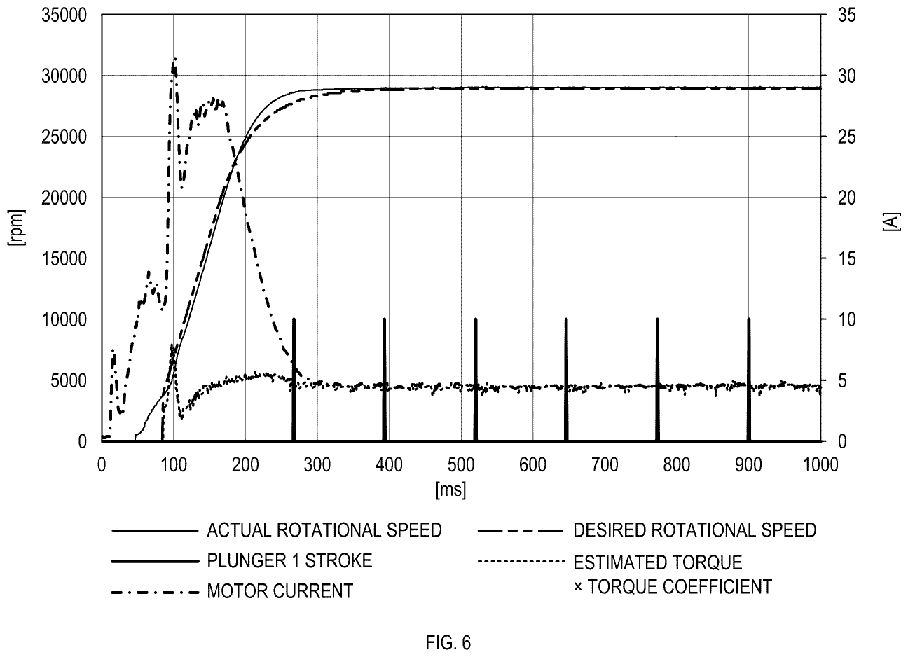

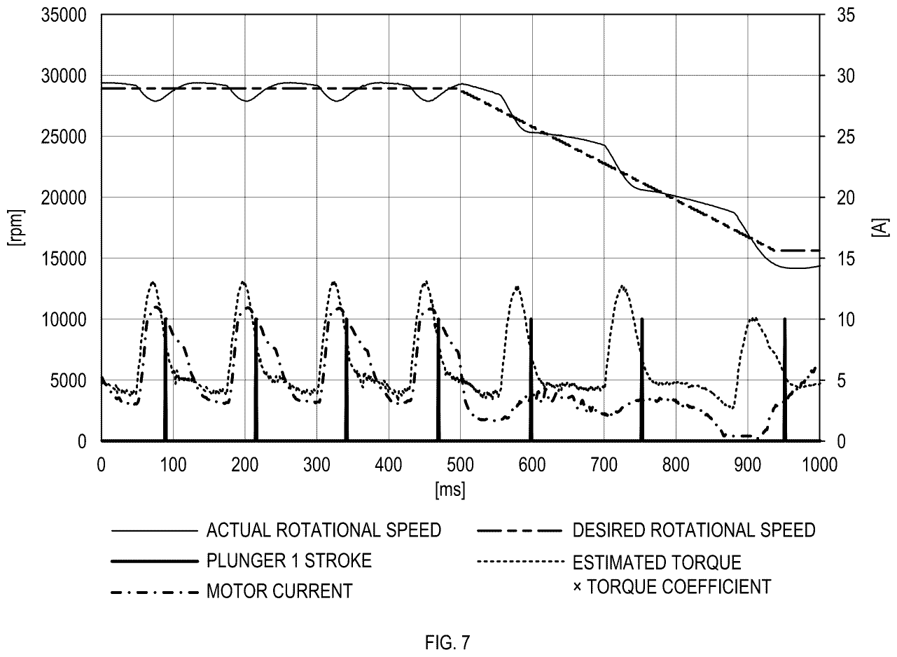

Here, as illustrated in FIG. 6, the motor current is maximized during acceleration of the motor 20. Therefore, during acceleration of the motor 20, there is a greater possibility of failing to detect the air entrapment state of the electric-powered lubricator 1 than during constant rotation of the motor 20. As illustrated in FIG. 7, the amplitude of the motor current decreases during deceleration of the motor 20. Therefore, during deceleration of the motor 20, even if the motor current varies in response to one reciprocation of the plunger 50, there is a possibility that the variation of the motor current is not detected. That is, during deceleration of the motor 20, there is a greater possibility of erroneously detecting the air entrapment state of the electric-powered lubricator 1 than during constant rotation of the motor 20.

Therefore, the air entrapment detector 90 does not have to execute air entrapment detection process when detecting the acceleration of the motor 20 on the basis of the desired rotational speed input from the rotational speed setter 86. The air entrapment detector 90 does not have to execute the air entrapment detection process when detecting the deceleration of the motor 20 on the basis of the input desired rotational speed.

The reciprocation number calculator 79 updates the number of reciprocations of the plunger 50 to a value increased by “1” every time the reciprocation determination signal is received from the reciprocation determiner 89. The reciprocation number calculator 79 does not update the number of reciprocations even when receiving the reciprocation determination signal while receiving the air entrapment detection signal from the air entrapment detector 90. When receiving no air entrapment detection signal from the air entrapment detector 90 and receiving the reciprocation determination signal from the reciprocation determiner 89, the reciprocation number calculator 79 updates the number of reciprocations of the plunger 50 to a value increased by “1”. As a result, the number of reciprocations of the plunger 50 corresponds to the dispensed amount of grease. Therefore, the calculation of the number of reciprocations of the plunger 50 corresponds to estimation of the dispensed amount of grease.

In another embodiment, the electric-powered lubricator 1 may include a fluid sensor in the vicinity of the dispensing port 66A to measure the dispensed amount of grease dispensed from the dispensing port 66A. The control circuit 80 may acquire the measured dispensed amount instead of calculating the number of reciprocations of the plunger 50. The electric-powered lubricator 1 may include a sensor that measures the movement of the plunger 50 in the vicinity of the plunger 50 to measure the number of reciprocations of the plunger 50. The control circuit 80 may acquire the measured number of reciprocations instead of calculating the number of reciprocations of the plunger 50. The control circuit 80 may correct the number of reciprocations by subtracting the number of times of occurrence of the air entrapment from the measured number of reciprocations on the basis of the air entrapment detection signal. The corrected number of reciprocations corresponds to the dispensed amount.

Immediately (for example, a few seconds) after the trigger switch 8 changes from off to on, the plunger 50 may move before dispensing the grease. Thus, the reciprocation number calculator 79 does not have to update the number of reciprocations even when receiving the reciprocation determination signal within a set length of time (for example, a few seconds) after receiving the first signal from the switch detector 78. The reciprocation number calculator 79 outputs the updated number of reciprocations to the display controller 85 every time the number of reciprocations is updated. Furthermore, the reciprocation number calculator 79 outputs a number difference to the operation controller 91. The number difference is a difference between the input set number of reciprocations and the current number of reciprocations.

The operation controller 91 receives the rotational speed level and the desired rotational speed, and updates the desired rotational speed on the basis of the rotational speed level. Specifically, in a case where the rotational speed level is a reference level (for example, the first level), the operation controller 91 outputs the input desired rotational speed to the motor drive controller 92 without updating the desired rotational speed. In a case where the rotational speed level is other than the reference level, the operation controller 91 multiplies the desired rotational speed by a level coefficient to update the desired rotational speed. The operation controller 91 outputs the updated desired rotational speed to the motor drive controller 92. The higher the rotational speed level, the larger the level coefficient.

The operation controller 91 receives the first signal or the second signal and determines whether the trigger 9 is in on state or off state. In a case where the input operation mode is the first mode and the trigger 9 is in on state, the operation controller 91 outputs a drive command to the motor drive controller 92. In a case where the input operation mode is the first mode or the second mode and the trigger 9 is in off state, the operation controller 91 outputs a stop command to the motor drive controller 92.

In a case where the input operation mode is the second mode, the trigger 9 is in on state, and the input number difference is one or more times, the operation controller 91 outputs the drive command to the motor drive controller 92. In a case where the input operation mode is the second mode, the trigger 9 is in on state, and the input number difference is less than one, the operation controller 91 outputs the stop command to the motor drive controller 92.

Furthermore, in a fourth embodiment to be described later, the operation controller 91 outputs the stop command to the motor drive controller 92 in a case where the air entrapment state continues for a predetermined length of time on the basis of the count value input from the clocker 88 and the air entrapment detection signal input from the air entrapment detector 90. In the present embodiment, the operation controller 91 does not have to receive the count value from the clocker 88 or does not have to receive the air entrapment detection signal from the air entrapment detector 90.

The motor drive controller 92 receives the first to third rotation signals from the first to third rotational position sensors, and calculates the actual rotational speed of the motor 20. When receiving the drive command from the operation controller 91, the motor drive controller 92 generates first to sixth drive control signals for the first to sixth semiconductor switches Q1 to Q6 on the basis of a difference between the desired rotational speed and the actual rotational speed. The motor drive controller 92 outputs the generated first to sixth drive control signals to the drive circuit 82. When receiving the stop command from the operation controller 91, the motor drive controller 92 generates first to sixth stop signals for the first to sixth semiconductor switches Q1 to Q6. The motor drive controller 92 outputs the generated first to sixth stop signals to the drive circuit 82.

The display controller 85 causes the first display 74 to display the rotational speed level input from the operation mode setter 87. The display controller 85 causes the second display 75A and the third display 75B to display the current number of reciprocations input from the reciprocation number calculator 79. In a case where the air entrapment detection signal is input, the display controller 85 notifies the user of the air entrapment and urges the user to perform air venting. For example, the display controller 85 may blink the second display 75A and the third display 75B to notify the user of the air entrapment. Alternatively, the display controller 85 may cause the second display 75A and the third display 75B to display a preset numerical value, symbol, character, or the like to notify the user of the air entrapment.

In another embodiment, the electric-powered lubricator 1 may include an indicator including, for example, a light-emitting diode. In a case where the air entrapment is detected, the control circuit 80 may notify the user of the air entrapment by lighting up or blinking the indicator instead of or in addition to blinking the second display 75A and the third display 75B or causing them to display the symbol or the like. In still another embodiment, the electric-powered lubricator 1 may include a buzzer. In a case where the air entrapment is detected, the control circuit 80 may notify the user of the air entrapment by causing the buzzer to output a warning sound instead of or in addition to blinking the second display 75A and the third display screen 75B or causing them to display the symbol or the like.

### 1-2. Desired Rotational Speed Setting

The setting of the desired rotational speed in a case where the operation mode is the first mode will be described with reference to FIG. 8. In FIG. 8, a first pulling amount X1 corresponds to the minimum position of the trigger 9. A second pulling amount X2 corresponds to the maximum position of the trigger 9. A third pulling amount X3a corresponds to a position between the minimum position and the maximum position. In the first relationship, the first pulling amount X1 is associated with a minimum rotational speed ωmin. In the first relationship, a range of the pulling amount from the third pulling amount X3a to the second pulling amount X2 is associated with a maximum speed ωmax.

In a range of the pulling amount from the first pulling amount X1 to the third pulling amount X3a, the rotational speed increases according to an increase in the pulling amount. In the range of the pulling amount from the third pulling amount X3a to the second pulling amount X2, the rotational speed is constant regardless of the pulling amount. Therefore, the first relationship has a first variable speed range Rv1 and a first constant speed range Rc1. The first variable speed range Rv1 is defined as a range where the rotational speed changes according to the pulling amount, and corresponds to the range of the pulling amount from the first pulling amount X1 to the third pulling amount X3a. The first constant speed range Rc1 is defined as a range where the rotational speed is constant regardless of the pulling amount, and corresponds to the range of the pulling amount from the third pulling amount X3a to the second pulling amount X2. In another embodiment, in the first relationship, the rotational speed may increase according to an increase in the pulling amount from the first pulling amount X1 to the second pulling amount X2. That is, in the other embodiment, the first relationship has the first variable speed range Rv1 and does not have to have the first constant speed range Rc1.

The range of the pulling amount in the first variable speed range Rv1 is wider than the range of the pulling amount in the first constant speed range Rc1. In the first mode, the user continuously pulls the trigger 9 until a desired amount of grease is dispensed. The control circuit 80 continuously drives the motor 20 while the trigger 9 is being pulled. There may be various demands on the dispensing speed. For example, there may be a demand for dispensing a desired amount of grease in a short period of time. In addition, there may be a demand for dispensing grease at a high speed at the start of dispensing, and dispensing grease at a low speed when the dispensed amount approaches a desired amount. Thus, in the first mode, it is desirable that the dispensing speed can be finely adjusted according to the pulling amount. Therefore, in the first relationship, the first variable speed range RV1 has a wide pulling amount range.

The setting of the desired rotational speed in a case where the operation mode is the second mode will be described with reference to FIG. 9. In the second relationship, the range of the pulling amount from the first pulling amount X1 to the second pulling amount X2 is associated with the maximum speed ωmax. The second relationship has a second constant speed range Rc2 and does not have the variable speed range. The range of the pulling amount in the second constant speed range Rc2 is from the first pulling amount X1 to the second pulling amount X2, and is wider than the range of the pulling amount in the first constant speed range Rc1.

In the second mode, the user inputs the set number of reciprocations of the plunger 50 according to the desired amount of grease. Then, the user pulls the trigger 9 in expectation that the desired amount of grease is automatically dispensed (that is, the user does not perform adjustment). Therefore, in the second mode, the demand for making the dispensing speed adjustable is low, and it is desirable that the desired amount of grease is dispensed. That is, it is desirable to reduce the failing detection and erroneous detection of the air entrapment and to make the number of times of dispensing the grease coincide with the set number of reciprocations. As described above, during acceleration of the motor 20, there is a greater possibility of failing to detect the air entrapment than during constant rotation. During deceleration of the motor 20, there is also a greater possibility of erroneously detecting the air entrapment than during constant rotation. Thus, the second relationship does not have the variable speed range where the detection accuracy of the air entrapment deteriorates.

### 1-3. Process

### 1-3-1. Main Process

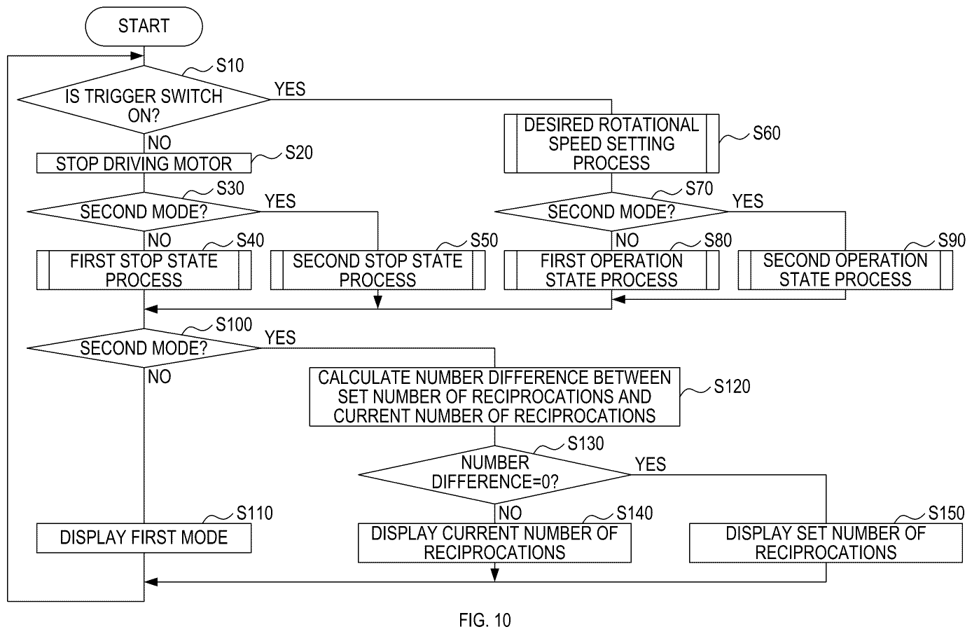

Main process executed by the control circuit 80 according to the first embodiment will be described with reference to the flowchart of FIG. 10. The control circuit 80 repeatedly executes the main process in a predetermined cycle.

In S10, the control circuit 80 determines whether the trigger switch 8 is on. When determining that the trigger switch 8 is on (S10: YES), the control circuit 80 proceeds to a process in S60. When determining that the trigger switch 8 is off (S10: NO), the control circuit 80 proceeds to a process in S20.

In S20, the control circuit 80 outputs the first to sixth stop signals to the drive circuit 82 to stop the motor 20. Thereafter, the control circuit 80 proceeds to a process in S30. In S30, the control circuit 80 determines whether the second mode is set as the operation mode. When determining that the second mode is set as the operation mode (S30: YES), the control circuit 80 proceeds to a process in S50. When determining that the first mode is set as the operation mode (S30: NO), the control circuit 80 proceeds to a process in S40.

In S40, the control circuit 80 executes first stop state process, and proceeds to a process in S100. Details of the first stop state process will be described later. In S50, the control circuit 80 executes second stop state process, and proceeds to the process in S100. Details of the second stop state process will be described later.

In S60, the control circuit 80 executes desired rotational speed setting process and sets the desired rotational speed of the motor 20. Thereafter, the control circuit 80 proceeds to a process in S70. Details of the desired rotational speed setting process will be described later.

In S70, the control circuit 80 determines whether the second mode is set as the operation mode. When determining that the second mode is set as the operation mode (S70: YES), the control circuit 80 proceeds to a process in S90. When determining that the first mode is set as the operation mode (S70: NO), the control circuit 80 proceeds to a process in S80.

In S80, the control circuit 80 executes first operation state process, and proceeds to the process in S100. Details of the first operation state process will be described later. In S90, the control circuit 80 executes second operation state process, and proceeds to the process in S100. Details of the second operation state process will be described later.

In S100, the control circuit 80 determines whether the second mode is set as the operation mode. When determining that the second mode is set as the operation mode (S100: YES), the control circuit 80 proceeds to a process in S120. When determining that the first mode is set as the operation mode (S100: NO), the control circuit 80 proceeds to a process in S110.

In S110, the control circuit 80 causes the set number display 75 to display the symbol or the like indicating the first mode to notify that the first mode is set as the operation mode. Thereafter, the control circuit 80 returns to the process in S10.

In S120, the control circuit 80 calculates the current number of reciprocations of the plunger 50, and calculates the number difference between the set number of reciprocations and the current number of reciprocations. Thereafter, the control circuit 80 proceeds to a process in S130.

In S130, the control circuit 80 determines whether the number difference calculated in S120 is 0. That is, the control circuit 80 determines whether the set amount of grease set by the user has been dispensed. When determining that the number difference is larger than 0 (S130: NO), the control circuit 80 proceeds to a process in S140. When determining that the number difference is 0 (S130 : YES), the control circuit 80 proceeds to a process in S150.

In S140, the control circuit 80 causes the set number display 75 to display the current number of reciprocations of the plunger 50. As a result, the user can recognize that the dispensing of the grease has not been completed. Thereafter, the control circuit 80 returns to the process in S10.

In S150, the control circuit 80 causes the set number display 75 to display the set number of reciprocations. As a result, the user can recognize that the dispensing of the grease has been completed. Thereafter, the control circuit 80 returns to the process in S10.

### 1-3-2. Desired Rotational Speed Setting Process

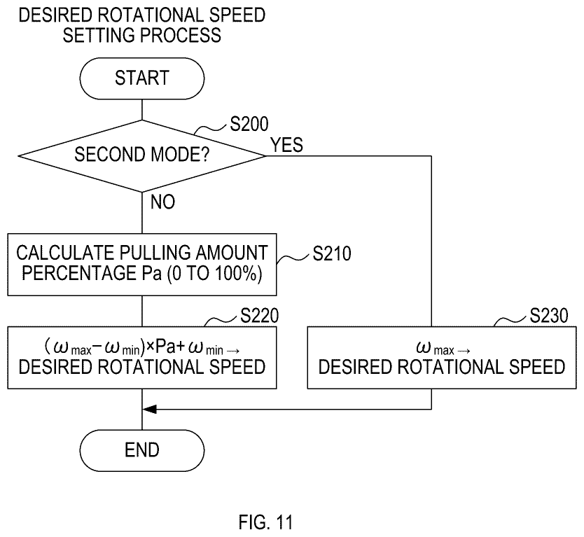

The desired rotational speed setting process executed by the control circuit 80 in S60 will be described with reference to the flowchart of FIG. 11.

In S200, the control circuit 80 determines whether the second mode is set as the operation mode. When determining that the second mode is set as the operation mode (S200: YES), the control circuit 80 proceeds to a process in S230. When determining that the first mode is set as the operation mode (S200: NO), the control circuit 80 proceeds to a process in S210.

In S210, the control circuit 80 calculates a pulling amount percentage Pa. The pulling amount percentage Pa is a value of 0 to 100%. As illustrated in FIG. 8, the control circuit 80 assigns the pulling amount percentage Pa=0 to 100% to the range of the pulling amount in the first variable speed range Rv1, and assigns the pulling amount percentage Pa=100% to the range of the pulling amount in the first constant speed range Rc1. That is, the control circuit 80 calculates the pulling amount percentage Pa=0% with respect to the first pulling amount X1 and calculates the pulling amount percentage Pa=100% with respect to the third pulling amount X3a. In a case where the actual pulling amount is between the first pulling amount X1 and the third pulling amount X3a, the control circuit 80 increases the pulling amount percentage Pa in proportion to an increase in the actual pulling amount. In a case where the actual pulling amount is between the third pulling amount X3a and the second pulling amount X2, the control circuit 80 calculates the pulling amount percentage Pa=100%.

In S220, the control circuit 80 calculates the desired rotational speed using the pulling amount percentage Pa calculated in S210, and ends this processing. Specifically, the control circuit 80 calculates the desired rotational speed on the basis of the equation: desired rotational speed=(ωmax−ωmin)×Pa+ωmin.

In S230, the control circuit 80 sets the maximum speed ωmax as the desired rotational speed, and ends this process.

### 1-3-3. First Stop State Process

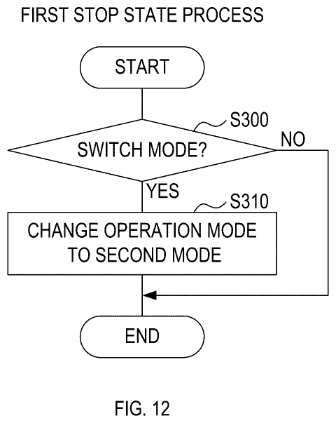

The first stop state process executed by the control circuit 80 in S40 will be described with reference to the flowchart of FIG. 12.

In S300, the control circuit 80 determines whether the user simultaneously presses the second switch 72 and the third switch 73 to request switching of the operation mode. When determining that the switching of the operation mode is requested (S300: YES), the control circuit 80 proceeds to a process in S310. When determining that the switching of the operation modes is not requested (S300: NO), the control circuit 80 ends this process.

In S310, the control circuit 80 changes the operation mode from the first mode to the second mode, and ends this process. When the trigger switch 8 is on, the control circuit 80 does not change the operation mode even if the second switch 72 and the third switch 73 are simultaneously pressed. The control circuit 80 changes the operation mode only when the trigger switch 8 is off.

### 1-3-4. Second Stop State Process

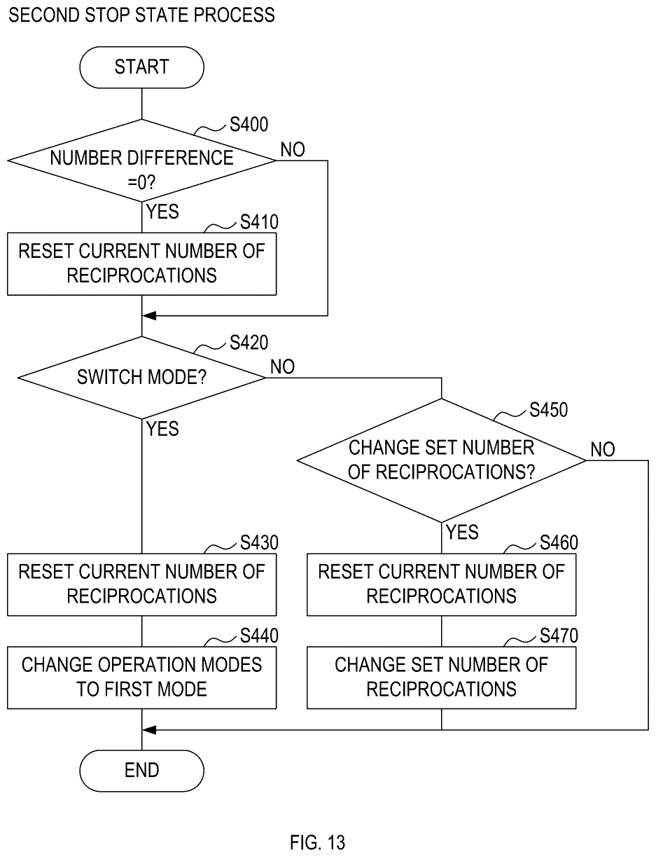

The second stop state process executed by the control circuit 80 in S50 will be described with reference to the flowchart of FIG. 13.

In S400, the control circuit 80 determines whether the number difference calculated in S120 of the previous process cycle is 0. When determining that the number difference is 0 (S400 : YES), the control circuit 80 proceeds to a process in S410. When determining that the number difference is larger than 0 (S400 : NO), the control circuit 80 skips the process in S410 and proceeds to a process in S420.

In S410, since the dispensing of the set amount of grease has been completed, the control circuit 80 resets the current number of reciprocations of the plunger 50 (that is, sets 0). Thereafter, the control circuit 80 proceeds to the process in S420.

In S420, the control circuit 80 determines whether the user simultaneously presses the second switch 72 and the third switch 73 to request switching of the operation mode. When determining that the switching of the operation mode is requested (S420: YES), the control circuit 80 proceeds to a process in S430. When determining that the switching of the operation mode is not requested (S420: NO), the control circuit 80 proceeds to a process in S450.

In S430, the control circuit 80 resets the current number of reciprocations of the plunger 50 to switch the operation mode. Thereafter, the control circuit 80 proceeds to a process in S440. In S440, the control circuit 80 changes the operation mode from the second mode to the first mode, and ends this process.

In S450, the control circuit 80 determines whether the user presses the second switch 72 and/or the third switch 73 to request a change of the set number of reciprocations. When determining that the change of the set number of reciprocations is requested (S450: YES), the control circuit 80 proceeds to a process in S460. When determining that the change of the set number of reciprocations is not requested (S450: NO), the control circuit 80 ends this process.

In S460, the control circuit 80 resets the current number of reciprocations of the plunger 50 to change the set number of reciprocations, and proceeds to a process in S470. In S470, the control circuit 80 changes the set number of reciprocations on the basis of the number of times the second switch 72 and/or the third switch 73 is pressed. Thereafter, the control circuit 80 ends this process.

### 1-3-5. First Operation State Process

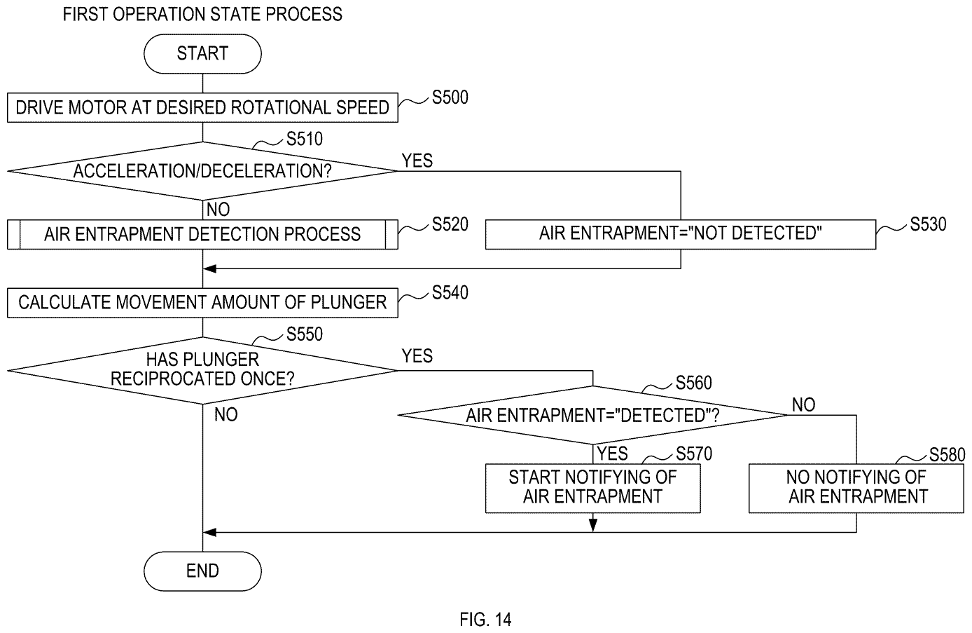

The first operation state process executed by the control circuit 80 in S80 will be described with reference to the flowchart of FIG. 14.

In S500, the control circuit 80 drives the motor 20 on the basis of the desired rotational speed set in S60. That is, the control circuit 80 controls the rotation of the motor 20 so as to hold the actual rotational speed of the motor 20 at the desired rotational speed. Thereafter, the control circuit 80 proceeds to a process in S510.

In S510, the control circuit 80 determines whether the motor 20 is accelerating or decelerating. Specifically, the control circuit 80 determines whether the motor 20 is accelerating or decelerating on the basis of the desired rotational speed or the actual rotational speed in a predetermined number of latest process cycles. When determining that the motor 20 is accelerating or decelerating (S510: YES), the control circuit 80 proceeds to a process in S530. When determining that the motor 20 is rotating at a constant speed (S510: NO), the control circuit 80 proceeds to a process in S520.

In S520, the control circuit 80 executes the air entrapment detection process on the basis of the actual rotational speed, the motor current, or the motor torque. When detecting the air entrapment, the control circuit 80 sets the air entrapment state to “detected”. When detecting no air entrapment, the control circuit 80 sets the air entrapment state to “not detected”. Thereafter, the control circuit 80 proceeds to a process in S540.

In S530, the control circuit 80 sets the air entrapment state to “not detected”, and proceeds to the process in S540. As described above, the detection accuracy of the air entrapment deteriorates during acceleration and deceleration of the motor 20. Therefore, the control circuit 80 does not execute the air entrapment detection process during acceleration or deceleration of the motor 20.

In S540, the control circuit 80 calculates a movement amount of the plunger 50 from a predetermined position on the basis of the first to third rotation signals and the speed reduction ratio of the speed reduction mechanism 43. The predetermined position is a position of the plunger 50 when the plunger 50 is previously determined to reciprocate once. Thereafter, the control circuit 80 proceeds to a process in S550.

In S550, the control circuit 80 determines whether the plunger 50 has reciprocated once on the basis of the movement amount calculated in S540. When determining that the plunger 50 has reciprocated once (S550: YES), the control circuit 80 proceeds to a process in S560. When determining that the plunger 50 has not reciprocated once (S550: NO), the control circuit 80 ends this processing.

In S560, the control circuit 80 determines whether the air entrapment state is set to “detected”. When determining that the air entrapment state is set to “detected” (S560: YES), the control circuit 80 proceeds to a process in S570. When determining that the air entrapment state is set to “not detected” (S560: NO), the control circuit 80 proceeds to a process in S580.

In S570, the control circuit 80 starts notifying the user of the air entrapment and ends this process. Specifically, the control circuit 80 blinks the symbol indicating the first mode displayed on the second display 75A and the third display 75B, and ends this process.

In S580, the control circuit 80 ends this process without notifying the user of the air entrapment. Specifically, the control circuit 80 lights up the symbol indicating the first mode displayed on the second display 75A and the third display 75B, and ends this process.

### 1-3-6. Second Operation State Process

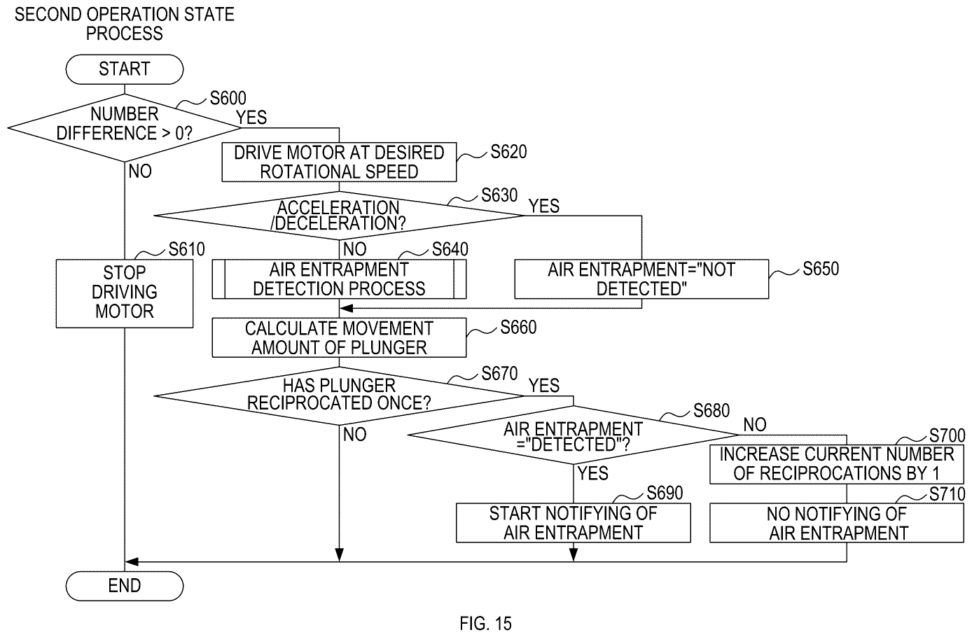

The second operation state process executed by the control circuit 80 in S90 will be described with reference to the flowchart of FIG. 15.

In S600, the control circuit 80 determines whether the number difference calculated in S120 of the previous process cycle is larger than 0. When determining that the number difference is larger than 0 (S600 : YES), the control circuit 80 proceeds to a process in S620. When determining that the number difference is 0 (S600 : NO), the control circuit 80 proceeds to a process in S610.

In S610, since the dispensing of the set amount of grease has been completed, the control circuit 80 outputs the first to sixth stop signals to the drive circuit 82 to stop the motor 20. Thereafter, the control circuit 80 ends this process.

In S620 to S680, the control circuit 80 executes processes similar to those in S500 to S560. When determining that the air entrapment state is set to “detected” in S680 (S680: YES), the control circuit 80 proceeds to a process in S690. When determining that the air entrapment state is set to “not detected” (S680: NO), the control circuit 80 proceeds to a process in S700.

In S690, the control circuit 80 executes a process similar to that in S570, and ends this process.

In S700, the control circuit 80 increases the current number of reciprocations of the plunger 50 by “1”, and proceeds to a process in S710.

In S710, the control circuit 80 executes a process similar to that in S580, and ends this process.

### 1-4. Effects

According to the first embodiment described in detail above, the following effects are obtained.
(1) The electric-powered lubricator 1 has the two operation modes having different correspondence relationships between the pulling amount of the trigger 9 and the rotational speed of the motor 20. Since the user can select one of the two operation modes, the degree of freedom in adjusting the operations of the electric-powered lubricator is increased. Therefore, the convenience of the electric-powered lubricator is improved.
(2) Since the first relationship of the first mode has the first variable speed range Rv1, the user can finely adjust the desired rotational speed of the motor 20 by operating the trigger 9.
(3) Since the second mode does not have the variable speed range, the user can drive the motor 20 at a constant desired rotational speed by operating the trigger 9. Furthermore, in the second mode, since the second relationship does not have the variable speed range, the erroneous detection or non-detection of the air entrapment is reduced. As a result, the control circuit can estimate the dispensed amount of grease with high accuracy in the second mode.
(4) In the second mode, the user can cause the electric-powered lubricator 1 to dispense the set amount of grease and the motor 20 to automatically stop only by operating the trigger 9 to turn on the trigger switch 8.
(5) In the first mode, the user can adjust the dispensed amount of grease by operating the trigger 9.
(6) The control circuit 80 estimates the dispensed amount of grease or acquires the measured dispensed amount. As a result, the control circuit 80 can stop driving the motor 20 in a case where the set dispensed amount is dispensed in the second mode.
(7) The control circuit 80 can calculate the number of reciprocations of the plunger 50 from the actual rotational speed of the motor 20 and the speed reduction ratio of the speed reduction mechanism 43. That is, the control circuit 80 can estimate the dispensed amount of grease from the actual rotational speed and the speed reduction ratio.

### 2. Second Embodiment

### 2-1. Differences from First Embodiment

Since the second embodiment has a similar basic configuration to that of the first embodiment, differences will be described below. Note that the same reference numerals as those in the first embodiment denote the same configurations, and reference is made to the preceding description.

In the second embodiment, the control circuit 80 executes desired rotational speed setting process different from the desired rotational speed setting process according to the first embodiment. Specifically, in the second mode according to the second embodiment, the desired rotational speed is set on the basis of a second relationship different from the second relationship of the second mode according to the first embodiment. In the first mode according to the second embodiment, the desired rotational speed is set on the basis of the same first relationship as that of the first mode according to the first embodiment. The control circuit 80 executes processes similar to the processes according to the first embodiment except for the desired rotational speed setting process.

### 2-2. Desired Rotational Speed Setting in Second Mode

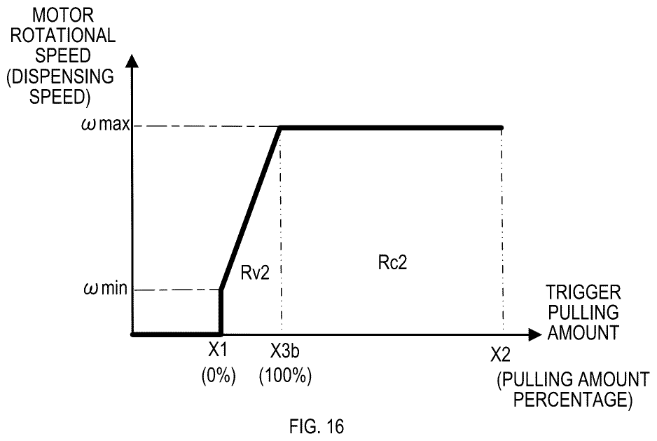

The setting of the desired rotational speed in a case where the operation mode is the second mode will be described with reference to FIG. 16. In the second mode, the user may need to finely adjust the operations of the electric-powered lubricator 1. Therefore, in the present embodiment, the second relationship has not only the constant speed range but also the variable speed range. Specifically, the second relationship has a second variable speed range Rv2 and the second constant speed range Rc2. The second variable speed range Rv2 corresponds to a range of the pulling amount from the first pulling amount X1 to a third pulling amount X3b. The third pulling amount X3b corresponds to a position between the minimum position and the maximum position. The second constant speed range Rc2 corresponds to a range of the pulling amount from the third pulling amount X3b to the second pulling amount X2. The first pulling amount X1 is associated with the minimum rotational speed ωmin. The third pulling amount X3b is associated with the maximum rotational speed ωmax. In the range of the pulling amount from the first pulling amount X1 to the third pulling amount X3b, the rotational speed increases according to an increase in the pulling amount.

The range of the pulling amount from the third pulling amount X3b to the second pulling amount X2 is associated with the maximum speed ωmax. In the range of the pulling amount from the third pulling amount X3b to the second pulling amount X2, the rotational speed is constant regardless of the pulling amount. The third pulling amount X3b according to the second embodiment is smaller than the third pulling amount X3a according to the first embodiment. Therefore, the range of the pulling amount in the second variable speed range Rv2 according to the second embodiment is narrower than the range of the pulling amount in the first variable speed range Rv1. The range of the pulling amount in the second constant speed range Rc2 according to the second embodiment is wider than the range of the pulling amount in the first constant speed range Rc1, and is narrower than the range of the pulling amount in the second constant speed range Rc2 according to the first embodiment. Therefore, in the present embodiment, the user can finely adjust the rotational speed of the motor 20 by operating the trigger 9 while basically rotating the motor 20 at a constant speed.

### 2-3. Desired Rotational Speed Setting Process

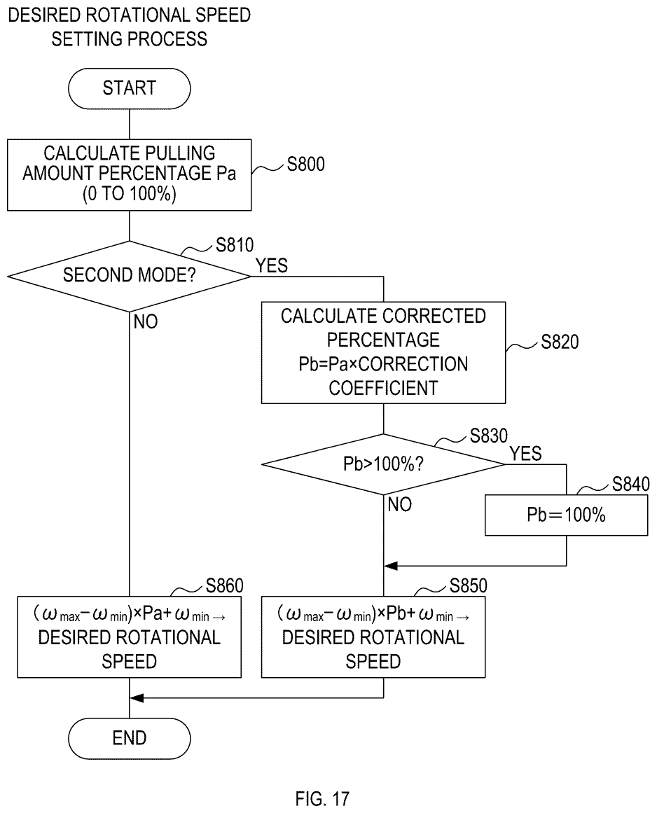

The desired rotational speed setting process executed by the control circuit 80 according to the second embodiment in S60 will be described with reference to the flowchart of FIG. 17.

In S800, the control circuit 80 executes a process similar to that in S210. Specifically, the control circuit 80 assigns the pulling amount percentage Pa=0 to 100% to the range of the pulling amount in the second variable speed range Rv2, and assigns the pulling amount percentage Pa=100% to the range of the pulling amount in the second constant speed range Rc2.

Subsequently, in S810, the control circuit 80 determines whether the second mode is set as the operation mode. When determining that the second mode is set as the operation mode (S810: YES), the control circuit 80 proceeds to a process in S820. When determining that the first mode is set as the operation mode (S810: NO), the control circuit 80 proceeds to a process in S860.

In S820, the control circuit 80 multiplies the pulling amount percentage Pa by a correction coefficient to calculate a corrected percentage Pb. The correction coefficient is an increase rate of the rotational speed in the variable speed range of the second mode in a case where an increase rate of the rotational speed in the variable speed range of the first mode is 1. Specifically, the correction coefficient is (X3a−X1)/(X3b−X1). Thereafter, the control circuit 80 proceeds to a process in S830.

In S830, the control circuit 80 determines whether the corrected percentage Pb calculated in S820 is larger than 100%. When determining that the corrected percentage Pb is larger than 100% (S830: YES), the control circuit 80 proceeds to a process in S840. When determining that the corrected percentage Pb is 100% or less (S830: NO), the control circuit 80 skips the process in S840 and proceeds to a process in S850.

In S840, the control circuit 80 sets the corrected percentage Pb to 100%, and proceeds to the process in S850. In S850, the control circuit 80 calculates the desired rotational speed using the corrected percentage Pb instead of the pulling amount percentage Pa, and ends this process. Specifically, the control circuit 80 calculates the desired rotational speed on the basis of the equation: desired rotational speed=(ωmax−ωmin)×Pb+ωmin.

In S860, the control circuit 80 executes a process similar to that in S220, and ends this process.

### 2-4. Effects

According to the second embodiment described in detail above, the effects (1), (2), and (4) to (7) of the first embodiment described above are obtained, and the following effect is further obtained.

(8) In the first mode, the user can finely adjust the rotational speed of the motor 20 by changing the pulling amount of the trigger 9 in a wide range. In the second mode, the user can drive the motor 20 at a constant rotational speed by operating the trigger 9, and can finely adjust the rotational speed of the motor 20 by changing the pulling amount of the trigger 9 in a narrow range.

### 3. Third Embodiment

### 3-1. Differences from First Embodiment

Since the third embodiment has a similar basic configuration to that of the first embodiment, differences will be described below. Note that the same reference numerals as those in the first embodiment denote the same configurations, and reference is made to the preceding description.

In the third embodiment, the control circuit 80 executes desired rotational speed setting process different from the desired rotational speed setting process according to the first embodiment. Specifically, in the second mode according to the third embodiment, the desired rotational speed is set on the basis of a second relationship different from the second relationship of the second mode according to the first embodiment. In the first mode according to the third embodiment, the desired rotational speed is set on the basis of the same first relationship as that of the first mode according to the first embodiment. The control circuit 80 executes processes similar to the processes according to the first embodiment except for the desired rotational speed setting process.

### 3-2. Desired Rotational Speed Setting in Second Mode

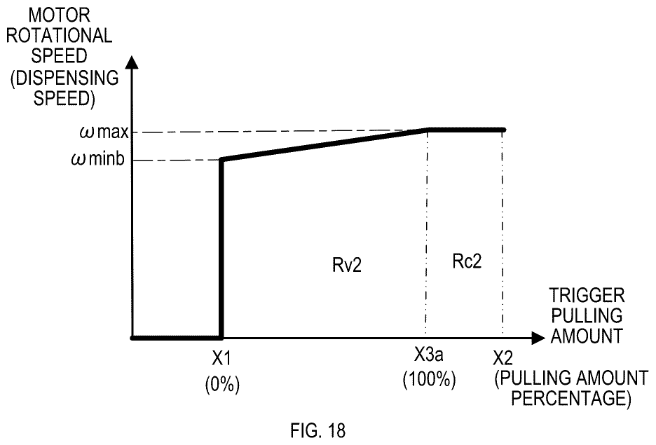

The setting of the desired rotational speed in a case where the operation mode is the second mode will be described with reference to FIG. 18. In the present embodiment, the second relationship has not only the constant speed range but also the variable speed range. Specifically, the second relationship has a second variable speed range Rv2 and the second constant speed range Rc2. The second variable speed range Rv2 corresponds to a range of the pulling amount from the first pulling amount X1 to the third pulling amount X3a. The second constant speed range Rc2 corresponds to a range of the pulling amount from the third pulling amount X3a to the second pulling amount X2. The first pulling amount X1 is associated with a specific rotational speed ωminb. The third pulling amount X3a is associated with the maximum rotational speed ωmax. The specific rotational speed ωminb is a minimum rotational speed in the second mode, and is larger than the minimum rotational speed ωmin in the first mode. In the range of the pulling amount from the first pulling amount X1 to the third pulling amount X3a, the rotational speed increases according to an increase in the pulling amount.

The range of the pulling amount from the third pulling amount X3a to the second pulling amount X2 is associated with the maximum speed ωmax. In the range of the pulling amount from the third pulling amount X3a to the second pulling amount X2, the rotational speed is constant regardless of the pulling amount. Therefore, a range of the rotational speed in the second variable speed range Rv2 according to the third embodiment is narrower than a range of the rotational speed in the first variable speed range Rv1. In the second variable speed range Rv2 according to the third embodiment, acceleration or deceleration small enough to enable the detection of the air entrapment is allowed. The second constant speed range Rc2 according to the third embodiment is equal to the first constant speed range Rc1. The range of the pulling amount in the second constant speed range Rc2 according to the third embodiment is narrower than the range of the pulling amount in the second constant speed range Rc2 according to the first embodiment. Therefore, in the present embodiment, the user can finely adjust the rotational speed of the motor 20 by operating the trigger 9 while basically rotating the motor 20 at a constant speed.

### 3-3. Desired Rotational Speed Setting Process

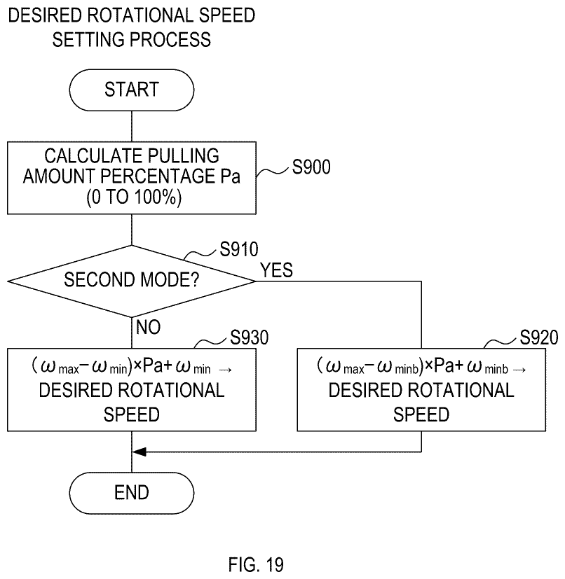

The desired rotational speed setting process executed by the control circuit 80 according to the third embodiment in S60 will be described with reference to the flowchart of FIG. 19.

In S900, the control circuit 80 executes a process similar to that in S210. Subsequently, in S910, the control circuit 80 determines whether the second mode is set as the operation mode. When determining that the second mode is set as the operation mode (S910: YES), the control circuit 80 proceeds to a process in S920. When determining that the first mode is set as the operation mode (S910: NO), the control circuit 80 proceeds to a process in S930.

In S920, the control circuit 80 calculates the desired rotational speed using the specific rotational speed ωminb instead of the minimum rotational speed ωmin, and ends this process. Specifically, the control circuit 80 calculates the desired rotational speed on the basis of the equation: desired rotational speed=(ωmax−ωminb)×Pa+ωminb.

In S930, the control circuit 80 executes a process similar to that in S220, and ends this process.

### 3-4. Effects

According to the third embodiment described in detail above, the effects (1), (2), and (4) to (7) of the first embodiment described above are obtained, and the following effect is further obtained.

(9) In the first mode, the user can finely adjust the rotational speed of the motor 20 by changing the pulling amount of the trigger 9 in a wide range. In the second mode, by operating the trigger 9, the user can drive the motor 20 at a constant rotational speed, and can accelerate or decelerate the motor 20 in a range of a rotational speed narrow enough to be able to reduce the erroneous detection or non-detection of the air entrapment.

### 4. Fourth Embodiment

### 4-1. Differences from First Embodiment

Since the fourth embodiment has a similar basic configuration to that of the first embodiment, differences will be described below. Note that the same reference numerals as those in the first embodiment denote the same configurations, and reference is made to the preceding description.

The fourth embodiment is different from the first embodiment in that the control circuit 80 stops the motor 20 in a case where the air entrapment is detected continuously for a predetermined length of time in addition to notifying the user of the air entrapment when detecting the air entrapment. Specifically, the control circuit 80 executes main process different from the main process according to the first embodiment, and additionally executes continuation determination process. In the fourth embodiment, the control circuit 80 executes the desired rotational speed setting process according to any one of the first to third embodiments.

### 4-2. Process

### 4-2-1. Main Process

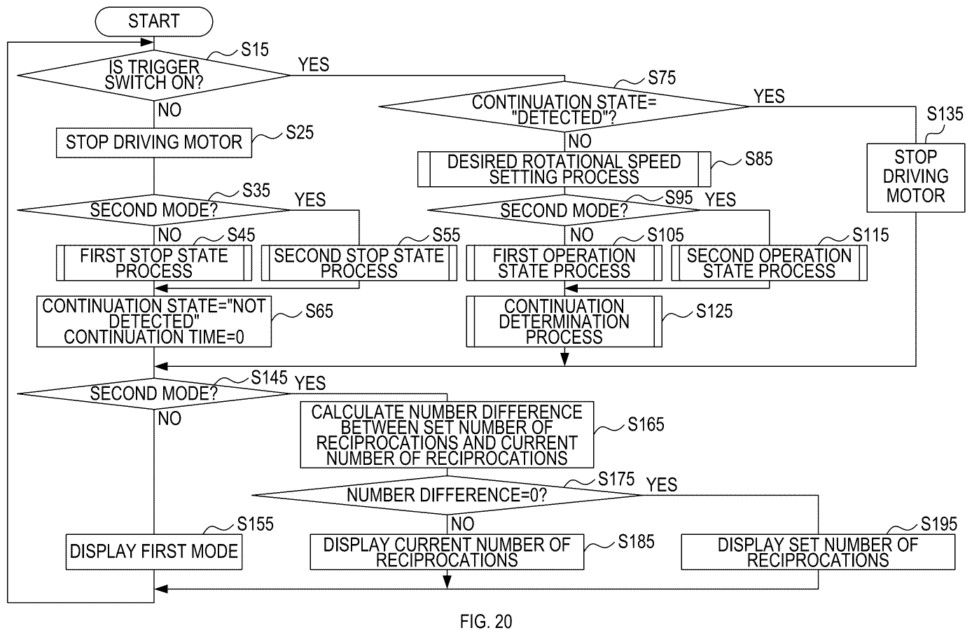

The main process executed by the control circuit 80 according to the fourth embodiment will be described with reference to the flowchart of FIG. 20.

In S15 to S55, the control circuit 80 executes the processes in S10 to S50. After executing the process in S45 or S55, the control circuit 80 proceeds to a process in S65. In S65, the control circuit 80 sets a continuation state of the air entrapment to “not detected” and sets a continuation time of the air entrapment to “0”. Thereafter, the control circuit 80 proceeds to a process in S145.

When determining that the trigger switch 8 is on in the process in S15 (S15: YES), the control circuit 80 proceeds to a process in S75. In S75, the control circuit 80 determines whether the air entrapment continuation state is set to “detected”. In a case where the air entrapment continuation state is detected in the continuation determination process to be described later, the continuation state is set to “detected”. When determining that the continuation state is set to “detected” (S75: YES), the control circuit 80 proceeds to a process in S135. When determining that the continuation state is set to “not detected” (S75: NO), the control circuit 80 proceeds to a process in S85.

In S85 to S115, the control circuit 80 executes processes similar to those in S60 to S90. After executing the process in S105 or S115, the control circuit 80 proceeds to a process in S125. In S125, the control circuit 80 executes the continuation determination process and determines whether the air entrapment continues for a predetermined length of time or more. Details of the continuation determination process will be described later. Thereafter, the control circuit 80 proceeds to the process in S145.

In S135, the control circuit 80 stops driving the motor 20 because the air entrapment continues for the predetermined length of time or more. That is, the control circuit 80 outputs the first to sixth stop signals to the drive circuit 82 to stop the motor 20. Thereafter, the control circuit 80 proceeds to the process in S145.

In S145 to S195, the control circuit 80 executes processes similar to those in S100 to S150.

### 4-2-2. Continuation Determination Process

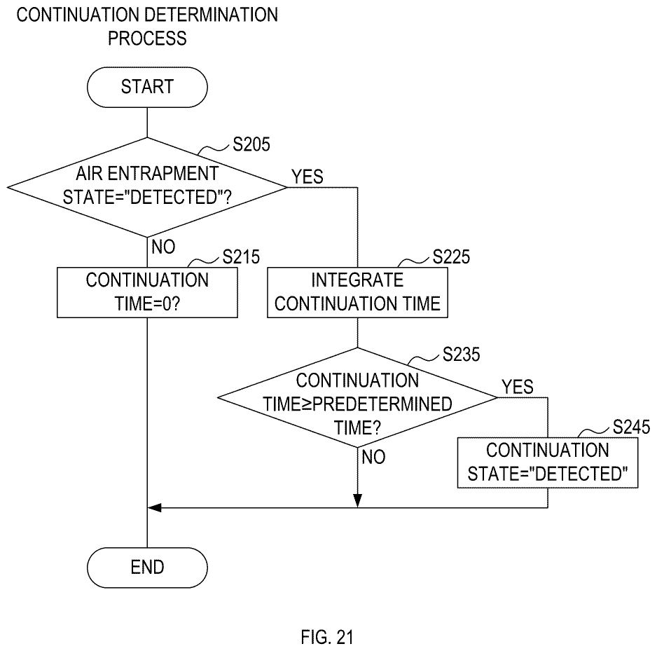

The continuation determination process executed by the control circuit 80 in S125 will be described with reference to the flowchart of FIG. 21.

In S205, the control circuit 80 determines whether the air entrapment state is set to “detected”. In a case where the air entrapment state is set to “detected” (S205: YES), the control circuit 80 proceeds to a process in S225. In a case where the air entrapment state is set to “not detected” (S205: NO), the control circuit 80 proceeds to a process in S215.

In S215, the control circuit 80 sets the air entrapment continuation time to “0”, and ends this process.

In S225, the control circuit 80 integrates the air entrapment continuation time. Specifically, the control circuit 80 adds the process cycle to the current continuation time. The process cycle is a time from the execution of the previous continuation determination process to the execution of the current continuation determination process. Thereafter, the control circuit 80 proceeds to a process in S235.

In S235, the control circuit 80 determines whether the continuation time is equal to or more than the predetermined length of time. When determining that the continuation time is equal to or more than the predetermined length of time (S235: YES), the control circuit 80 proceeds to a process in S245. When determining that the continuation time is less than the predetermined length of time (S235: NO), the control circuit 80 ends this process.

In S245, the control circuit 80 sets the continuation state to “detected”, and ends this process.

### 4-3. Effects

According to the fourth embodiment described in detail above, the effects (1) to (9) of the first embodiment described above are obtained, and the following effect is further obtained.

(10) The control circuit 80 stops driving the motor 20 in a case where the air entrapment state continues for the predetermined length of time. As a result, it is possible to prevent the motor 20 from being continuously driven without dispensing the grease.

### 5. Correspondence between Terms

In the first to fourth embodiments, the trigger 9 corresponds to an example of the drive switch in the summary of embodiments, and the pulling amount of the trigger 9 corresponds to the operation amount of the drive switch in the summary of embodiments. In the first to fourth embodiments, the second switch 72 and/or the third switch 73 corresponds to an example of the selection switch in the summary of embodiments.

### 6. Other Embodiments

Although the first to fourth embodiments of the present disclosure have been described above, the present disclosure is not limited to the first to fourth embodiments, and various modifications can be made.

(a) In the above embodiments, the pump 60 is a reciprocating pump including a plunger, but is not limited thereto, and any type of pump that is driven by the motor 20 may be used. The pump 60 may be a reciprocating pump such as a piston pump or a diaphragm pump. Alternatively, the pump 60 may be a rotary pump such as a gear pump, a screw pump, or a vane pump. Alternatively, the pump 60 is not limited to a positive displacement pump such as a reciprocating pump or a rotary pump, and may be a non-positive displacement pump such as a centrifugal pump, a propeller pump, or a viscous pump. Regardless of the type of the pump 60, the control circuit 80 can estimate the dispensed amount of grease from the actual rotational speed of the motor 20, the speed reduction ratio, and the predetermined amount dispensed at one time.

(b) In the above embodiments, the lubricant dispensed from the electric-powered lubricator 1 is semi-solid grease, but the lubricant is not limited to the grease. The lubricant may be a liquid lubricant or a material having lubricity other than the grease and the lubricant.

(c) A plurality of functions of one component in the above embodiments may be implemented by a plurality of components, or one function of one component may be implemented by a plurality of components. A plurality of functions of a plurality of components may be implemented by one component, or one function implemented by a plurality of components may be implemented by one component. Part of the configuration of any of the above embodiments may be omitted. At least part of the configuration of any of the above embodiments may be added to or replaced with the configuration of another one of the above embodiments.

What is claimed is:

1. An electric-powered lubricator comprising:
a motor configured to generate a driving force;
a drive circuit configured to drive the motor;
a pump including a dispensing port configured to dispense a lubricant, and configured to dispense the lubricant from the dispensing port at a speed corresponding to a rotational speed of the motor by the driving force generated by the motor;
a drive switch configured to be manually operated by a user to drive the motor;
a selection switch configured to be manually operated by the user to select a first mode or a second mode, the first mode and the second mode each being an operation mode of the electric-powered lubricator, the first mode associating an operation amount of the drive switch with the rotational speed in a first relationship, the second mode associating the operation amount with the rotational speed in a second relationship different from the first relationship, a variable speed range in the first relationship being wider than a variable speed range in the second relationship, and the variable speed range being defined as a range where the rotational speed changes according to the operation amount; and
a control circuit configured to control the motor through the drive circuit based on (i) a actual operation amount of the drive switch manually operated and (ii) the first mode or the second mode selected through the selection switch.

2. The electric-powered lubricator according to claim 1, wherein
the control circuit is configured to continuously drive the motor through the drive circuit while the drive switch is being operated based on the first mode being selected through the selection switch.

3. The electric-powered lubricator according to claim 1, wherein
the control circuit is configured to stop the motor through the drive circuit based on (i) the second mode being selected through the selection switch and (ii) a set amount of the lubricant having been dispensed from the dispensing port.

4. The electric-powered lubricator according to claim 1, wherein
the control circuit is configured to estimate a dispensed amount or acquire the dispensed amount measured based on the second mode being selected through the selection switch, the dispensed amount corresponding to an amount of the lubricant dispensed from the dispensing port.

5. The electric-powered lubricator according to claim 4, wherein
the pump further includes:
a chamber configured to communicate with the dispensing port and store the lubricant; and
a plunger configured to reciprocate within the chamber by the driving force and dispense the lubricant from the dispensing port, and
the control circuit is configured to estimate the dispensed amount based on the number of reciprocations of the plunger within the chamber.

6. The electric-powered lubricator according to claim 1, wherein
the first relationship has the variable speed range,
the second relationship has a constant speed range and does not have the variable speed range, and
the constant speed range is defined as a range where the rotational speed is constant regardless of the operation amount.

7. The electric-powered lubricator according to claim 1, wherein
the first relationship has a first variable speed range corresponding to the variable speed range,
the second relationship has a constant speed range and a second variable speed range corresponding to the variable speed range,
the constant speed range is defined as a range where the rotational speed is constant regardless of the operation amount, and
a range of the operation amount in the second variable speed range is narrower than a range of the operation amount in the first variable speed range.

8. The electric-powered lubricator according to claim 1, wherein
the first relationship has a first variable speed range corresponding to the variable speed range,
the second relationship has a constant speed range and a second variable speed range corresponding to the variable speed range,
the constant speed range is defined as a range where the rotational speed is constant regardless of the operation amount, and
a range of the rotational speed in the second variable speed range is narrower than a range of the rotational speed in the first variable speed range.

9. The electric-powered lubricator according to claim 1, wherein
the control circuit is configured to
set a desired rotational speed of the motor based on (i) the actual operation amount of the drive switch manually operated and (ii) the first mode or the second mode selected through the selection switch, and
maintain an actual rotational speed of the motor at the desired rotational speed.

10. The electric-powered lubricator according to claim 1, wherein
the control circuit is configured to
change the operation mode during stop of the motor based on manual operation of the selection switch by the user.

11. The electric-powered lubricator according to claim 3, wherein
the set amount corresponds to the number of dispensing times set by the user.

12. A method of controlling dispensing of a lubricant from an electric-powered lubricator, the method comprising:
setting a first mode or a second mode as an operation mode of the electric-powered lubricator based on manual operation of a selection switch of the electric-powered lubricator by a user, the first mode associating an operation amount of a drive switch of the electric-powered lubricator with a rotational speed of a motor in a first relationship, the motor being configured to drive a pump of the electric-powered lubricator, the second mode associating the operation amount with the rotational speed in a second relationship different from the first relationship, a variable speed range in the first relationship being wider than a variable speed range in the second relationship, the variable speed range being defined as a range where the rotational speed changes according to the operation amount; and
controlling the motor based on (i) an actual operation amount of the drive switch and (ii) the operation mode set through the selection switch based on manual operation of the drive switch by the user.
